(19) United States
(12) Patent Application Publication
(10) Pub. No.: US 2022/0033556 A1
(43) Pub. Date: Feb. 3, 2022

(54) DEGRADABLE POLYETHERS

(71) Applicant: King Abdullah University of Science and Technology, Thuwal (SA)

(72) Inventors: Xiaoshuang FENG, Thuwal (SA); Jobi VARGHESE, Thuwal (SA); Yves GNANOU, Thuwal (SA); Nikos HADJICHRISTIDIS, Thuwal (SA); Mingchen JIA, Thuwal (SA); Dhanya AUGUSTINE, Thuwal (SA)

(21) Appl. No.: 17/277,125

(22) PCT Filed: Sep. 17, 2019
(86) PCT No.: PCT/IB2019/057827

§ 371 Date: Mar. 17, 2021

Related U.S. Application Data
(60) Provisional application No. 62/732,336, filed on Sep. 17, 2018.
(60) Provisional application No. 62/782,783, filed on Dec. 20, 2018.

(51) Int. Cl. C08F 293/00; C08G 65/12; C08G 65/26; C08G 63/664; C08G 64/34

(52) U.S. Cl. CPC C08F 293/00; C08G 65/12; C08G 65/2615; C08G 63/664; C08G 2650/22; C08G 2230/00; C08L 2203/02; C08L 2207/53; C08G 64/34

(57) ABSTRACT

Embodiments include degradable polyethers comprising ester units from a cyclic ester or carbonate units from carbon dioxide incorporated into a poly(ethylene oxide) backbone or a multifunctional core of a degradable polyether star. Embodiments include methods of forming a degradable polyether comprising contacting an ethylene oxide monomer with a lactide monomer or carbon dioxide in the presence of an alkyl borane and an initiator. Embodiments include methods of forming degradable polyether stars comprising contacting a diepoxide monomer with carbon dioxide and/or a cyclic ester in the presence of an initiator and a first amount of an alkyl borane to form a multifunctional core comprising degradable carbonate linkages and/or degradable ester linkages, and contacting the multifunctional core with an ethylene oxide monomer in the presence of a second amount of an alkyl borane to form arms of a polyether attached to the degradable multifunctional core.

### BACKGROUND

Poly(ethylene oxide) (PEO), often referred to as poly(ethylene glycol), is a FDA-approved polymer for clinical use because of its unique properties such as its chemical stability, its hydrophilicity, its biocompatibility and above all its non-recognition by the immune system (stealth effect). The presence of functional groups at chain ends allows the conjugation of biologically active molecules with PEO (PEGylation). Thus, so-called PEGylated cargos can be transported to the target site without being recognized by the immune system. To lengthen circulation times and improve the steric shielding effect, the hydrodynamic size of conjugates after PEGylation should be above 6-8 nm, which is the threshold of glomerular filtration, to avoid renal clearance. However, due to the non-degradability of PEO, the molar mass of PEO used should not exceed 40 kg/mol due to its potential bioaccumulation in vivo.

To overcome this issue, much effort has been devoted to imparting degradability to the chains of PEO by incorporating degradable linkages within their backbone. The most common strategy has been through polycondensation of PEO telechelics, involving the incorporation of esters, disulfide, acetal, oxime, imine, or carbonate linkages into PEO polycondensates. However, the latter PEO derivatives have exhibited very broad polydispersities and ill-defined structures.

A classic strategy has involved anionically copolymerizing ethylene oxide with other monomers, and then introducing degradable linkages within the PEO backbone. For instance, copolymerized EO and epichlorohydrin can be subjected to an efficient elimination reaction to generate degradable methylene ethylene oxide (MEO) repeat units within a PEO backbone. Similarly, EO can be copolymerized with 3,4-epoxy-1-butene (EPB) via anionic ring-opening polymerization (AROP), and then the allyl moieties of EPB can be isomerized into pH-cleavable vinyl ethers. An alternative strategy has involved post-oxidation of the prepared or commercially available PEO to generate hydrolysable linkages along the backbone. For instance, hemiacetals can be randomly introduced into the backbone of PEOs through a Fenton reaction by hydrogen peroxide and ferric chloride at a neutral pH. A ruthenium-catalyzed post-polymerization oxyfunctionalization of PEGs generating acid-degradable poly[(ethylene glycol)-co-(glycolic acid)] copolymers has also been reported. Although these last two approaches afford degradable PEG with well-defined structures and narrow polydispersities, they suffer from the following drawbacks: many steps are needed for the synthesis and compatibility issues with functional groups should be overcome during the post-polymerization step.

Polylactide (PLLA) is another important polymer, being widely utilized in the biomedical area due to its biocompatibility and degradability, as well as its availability from bioresources. However, because of its high crystallinity, hydrophobic nature, and degradability, PLLA has found biomedical applications different than those of PEO. Copolymerization of LLA with other monomers represents a general strategy to tune its physical properties for various biomedical applications. For instance, di- or triblock copolymers have been obtained by sequential polymerization of various monomers and LLA. With respect to epoxide monomers, and namely ethylene oxide, only a limited number of investigations have been reported in the literature describing their copolymerizations with LLA. Besides the attempt to grow PLLA blocks from a PEO macroinitiator, one report mentioned the use of various Al and Sn—Al bimetallic catalysts to prepare LLA-EO multiblock copolymers exhibiting broad distributions. Another report resorted to the classical Vandenberg catalysts to obtain random copolymers of LLA and EO of high molar mass. In each of these reports, the principle focus was to investigate the “copolymerizability” of LLA and epoxides using various coordinating catalysts and to characterize the type of copolymers eventually obtained: multiblock in the first case and random in the second case.

### SUMMARY

In general, embodiments of the present disclosure describe degradable polyethers, methods of forming degradable polyethers, degradable polyethers conjugated with biologically active molecules, and the like.

Embodiments of the present disclosure describe a degradable polyether comprising ester units from a cyclic ester (e.g., lactide) or carbonate units from carbon dioxide incorporated into a poly(ethylene oxide) backbone or a multifunctional polycarbonate core of a poly(ethylene oxide) star.

Embodiments of the present disclosure describe a method of forming a degradable polyether comprising contacting an ethylene oxide monomer with a cyclic ester or carbon dioxide in the presence of an alkyl borane and an initiator.

Embodiments of the present disclosure describe a modified biological molecule comprising a biologically active molecule conjugated with a degradable polyether having ester units or carbonate units incorporated into a poly(ethylene oxide) backbone.

Embodiments of the present disclosure describe methods of forming degradable polyether stars comprising contacting a diepoxide monomer with carbon dioxide and/or a cyclic ester in the presence of an initiator and a first amount of an alkyl borane to form a multifunctional core comprising degradable carbonate linkages and/or degradable ester linkages, and contacting the multifunctional core with an ethylene oxide monomer in the presence of a second amount of an alkyl borane to form arms of a polyether attached to the degradable multifunctional core.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of forming a degradable copolymer, according to one or more embodiments of the present disclosure.

FIG. 2 is a schematic diagram of a reaction scheme in which a degradable copolymer is formed, according to one or more embodiments of the present disclosure.

FIG. 3 is a flowchart of a method of forming a degradable polyether star, according to one or more embodiments of the present disclosure.

FIG. 4 is a representative ¹H NMR spectrum of P(EO-co-LLA) random copolymer (entry 7 of Table 1), according to one or more embodiments of the present disclosure.

FIG. 5 is a graphical view of GPC traces of various copolymer samples targeted from 100 DP to 500 DP (Table 1), according to one or more embodiments of the present disclosure.

FIG. 6 is an IR spectrum of a copolymer (entry 21, Table 1) showing azide incorporation, according to one or more embodiments of the present disclosure.

FIG. 7 is a graphical view of a reactivity ratio plot for P₄/PMBA in toluene (Entry 1, 2, 3 of Table 2), according to one or more embodiments of the present disclosure.

FIG. 8 is a graphical view of a reactivity ratio plot for TBACl in toluene (Entry 4, 5, 6 of Table 2), according to one or more embodiments of the present disclosure.

FIG. 9 is a graphical view of a reactivity ratio plot for PPNCl in toluene (Entry 7, 8, 9 of Table 2), according to one or more embodiments of the present disclosure.

FIG. 10 is a graphical view of DSC traces of copolymers P(EO-co-LLA) with different ester compositions, according to one or more embodiments of the present disclosure.

FIG. 11 is a graphical view of GPC traces overlay of copolymer P(EO-co-LLA) before and after degradation (Entry 12, Table 1), according to one or more embodiments of the present disclosure.

FIG. 12 is a reaction scheme illustrating the synthesis of PEO homostars (PVDOX-EO), according to one or more embodiments of the present disclosure.

FIG. 13 shows ¹H NMR characterization of Entry 21, Table 4, according to one or more embodiments of the present disclosure.

FIG. 14 shows GPC trace of Entry 21, Table 4, according to one or more embodiments of the present disclosure.

FIG. 15 shows ¹H NMR characterization of Entry 22, Table 4, according to one or more embodiments of the present disclosure.

FIG. 16 shows GPC trace of Entry 22, Table 4, according to one or more embodiments of the present disclosure.

FIG. 17 shows ¹H NMR characterization of Entry 23, Table 4, according to one or more embodiments of the present disclosure.

FIG. 18 shows GPC trace of Entry 23, Table 4, according to one or more embodiments of the present disclosure.

FIG. 19 shows ¹H NMR characterization of Entry 24, Table 4, according to one or more embodiments of the present disclosure.

FIG. 20 shows GPC trace of Entry 24, Table 4, according to one or more embodiments of the present disclosure.

FIG. 21 shows ¹H NMR characterization of Entry 25, Table 4, according to one or more embodiments of the present disclosure.

FIG. 22 shows GPC trace of Entry 25, Table 4, according to one or more embodiments of the present disclosure.

FIG. 23 shows ¹H NMR characterization of Entry 26, Table 4, according to one or more embodiments of the present disclosure.

FIG. 24 shows GPC trace of Entry 26, Table 4, according to one or more embodiments of the present disclosure.

FIG. 25 shows GPC trace of Entry 27, Table 5, according to one or more embodiments of the present disclosure.

FIG. 26 shows GPC trace of Entry 28, Table 5, according to one or more embodiments of the present disclosure.

FIG. 27 shows GPC trace of Entry 30, Table 5, according to one or more embodiments of the present disclosure.

FIG. 28 shows GPC trace of Entry 33, Table 5, according to one or more embodiments of the present disclosure.

FIG. 29 shows ¹H NMR characterization of Entry 33, Table 5, according to one or more embodiments of the present disclosure.

### DETAILED DESCRIPTION

The present invention is directed to methods of forming degradable polyethers, and the like. The degradable polyethers can comprise a controllable and tunable content of degradable ester linkages (e.g., ester units) or degradable carbonate linkages (e.g., carbonate units) incorporated into a polyether backbone or multifunctional core of a polyether star. For example, embodiments include degradable polyethers prepared as random copolymers comprising ester units from a cyclic ester (e.g., L-lactide) and/or carbonate units from carbon dioxide randomly incorporated into the polyether backbone. Embodiments also include degradable polyethers prepared as star polymers comprising arms of a polyether attached to a multifunctional core comprising carbonate units or ester units. The methods disclosed herein provide control over the amount and/or length of the ester units and carbonate units incorporated into the degradable polyether. For example in one embodiment, the degradable polyether can comprise about 5% ester units into the polyether backbone, with an average length of about two adjacent ester groups or less per ester unit. By incorporating degradable linkages into the polymer backbone in this way, a character of degradability can be imparted to the polyether, without modifying the intrinsic properties of the polymers.

The degradable polyethers of the present disclosure can be directly prepared by anionic ring-opening copolymerization of an ethylene oxide monomer with a cyclic ester or carbon dioxide. The anionic copolymerization can proceed in the presence of an activator—namely, an alkyl borane—and an initiator. The presence of the activator can selectively increase the reactivity of the ethylene oxide monomer, as well as suppress transesterification reactions and/or the formation of cyclic carbonates. For example, the activator and initiator can react under stoichiometric conditions to form an ate complex. The ate complex can be used to initiate anionic copolymerization. In some embodiments, the growing ate complex is not sufficiently nucleophilic to activate the ethylene oxide monomer, in which case the activator can be provided in stoichiometric excess of the initiator to ensure activation of the ethylene oxide monomer. By proceeding in this way, the content of degradable linkages can be precisely controlled to afford well-defined degradable polyethers with controllable molar mass and narrow polydispersity can be achieved. In addition, the method is general and can be applied to synthesize functionalized linear and/or branched poly(ethylene oxide)s, as well as degradable poly(ethylene oxide) star polymers, among others.

In some embodiments, the degradable polyethers can further be prepared as difunctional or hetero-difunctional polyethers for the modification of biological molecules. For example, the degradable polyethers can be formed such that the terminal ends of the degradable polyethers have functional groups that allow the conjugation of biologically active molecules with poly(ethylene oxide) through a process generally referred to as PEGylation. Accordingly, embodiments of the present disclosure further describe modified biological molecules comprising a biologically active molecule conjugated with the degradable polyethers of the present disclosure. In this way, biologically active molecules—such as peptides, proteins, and enzymes, among others—can be modified through covalent conjugation with the degradable polyethers.

### Definitions

The terms recited below have been defined as described below. All other terms and phrases in this disclosure shall be construed according to their ordinary meaning as understood by one of skill in the art.

As used herein, “degradable polyether” refers to any polyether comprising degradable linkages. For example, the degradable linkages can be provided in the polymer backbone, or in the group between the polymer backbone and one or more terminal functional groups of the polymer, or in a multifunctional core of a star polymer, among other places. In the context of star polymers, a degradable polyether star can comprise polyether homostars or heterostars with multifunctional cores comprising degradable linkages.

As used herein, “degradable linkages” refers to any unit or segment of a polymer capable of being degraded. The term degradable linkages includes ester units and carbonate units. Accordingly, the terms “ester unit(s)” and “degradable ester linkage(s),” as well as “carbonate unit(s)” and “degradable carbonate linkage(s),” and the like may be used interchangeably herein. The mechanism by which the linkages degrade can depend on the target application. For example, the degradable linkages can be hydrolytically degradable linkages, enzymatically degradable linkages, pH-degradable linkages, acid-degradable linkages, etc.

As used herein, the term “cyclic ester” includes monoesters, cyclic diesters, cyclic triesters, and the like. A non-limiting example of a cyclic ester is lactide. As used herein, “lactide” can refer to one or more of lactide's three stereoisomeric forms. The three stereoisomeric forms of lactide include L-lactide, D-lactide, and meso-lactide.

As used herein, “ester unit” refers to any segment of a polymer comprising at least one ester group. The polymer can comprise a plurality of ester units. Each of the ester units can comprise one or more adjacent ester groups. An ester group can be generally represented by the chemical formula: (—RC(═O)OR′—)ₐ, wherein a is at least 1, wherein R and R′ are general, not particularly limited, and can depend on the monomer from which the ester group is obtained. For example, an ester unit can comprise one or more adjacent lactides. The ester units of a polymer can be described by an average length, wherein the average length of ester units can refer to the average number of adjacent ester groups found in the polymer.

As used herein, “carbonate unit” refers to any segment of a polymer comprising at least one carbonate group. A polymer can comprise a plurality of carbonate units. Each of the carbonate units can comprise one or more adjacent carbonate groups. A carbonate group can be generally represented by the chemical formula: (—ROC(═O)OR′—)ₐ, wherein a is at least 1, wherein R and R′ are general, not particularly limited, and can depend on the monomer form which the carbonate group is obtained. For example, a carbonate unit can comprise one or more adjacent monoethyl carbonates. The carbonate units of a polymer can be described by an average length, wherein the average length of carbonate units can refer to the average number of adjacent carbonate groups found in the polymer.

As used herein, the term “aliphatic” or “aliphatic group” refers to a hydrocarbon moiety, wherein the hydrocarbon moiety can be straight chained (e.g., unbranched or linear), branched, or cyclic and/or can be completely saturated, or contain one or more units of unsaturation, but which is not aromatic. The term “unsaturated” refers to a moiety that has one or more double and/or triple bonds. The term “aliphatic” thus includes alkyl, cycloalkyl, alkenyl, cycloalkenyl, alkynyl, or cycloalkenyl groups, and combinations thereof. An aliphatic group can comprise 30 carbon atoms or less, or any number of carbon atoms in the range of 1 to 30, or any increment within the range of 1 to 30 carbon atoms. Non-limiting examples of aliphatic groups include linear or branched alkyl, alkenyl and alkynyl groups, and mixtures thereof such as (cycloalkyl)alkyl groups, (cycloalkenyl)alkyl groups and (cycloalkyl)alkenyl groups.

As used herein, the term “alkyl” refers to saturated, straight- or branched-chain hydrocarbon radicals in which a hydrogen atom has been removed from an aliphatic moiety. An alkyl group can optionally include a straight or branched chain with 1 to 20 carbons. Non-limiting examples alkyls include methyl group, ethyl group, n-propyl group, iso-propyl group, n-butyl group, iso-butyl group, sec-butyl group, tert-butyl group, sec-pentyl, iso-pentyl, n-pentyl group, neopentyl, n-hexyl group, sec-hexyl, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1, 1-dimethylpropyl group, 1,2-dimethylpropyl group, 2,2-dimethylpropyl group, 1-ethylpropyl group, n-hexyl group, 1-ethyl-2-methylpropyl group, 1, 1,2-trimethylpropyl group, 1-ethylbutyl group, 1-methylbutyl group, 2-methylbutyl group, 1, 1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group, and the like.

As used herein, the term “alkenyl” refers to a group derived from the removal of a hydrogen atom from a straight- or branched-chain aliphatic moiety having at least one carbon-carbon double bond. The term “alkynyl,” as used herein, refers to a group derived from the removal of a hydrogen atom from a straight- or branched-chain aliphatic moiety having at least one carbon-carbon triple bond. Non-limiting examples of alkenyl groups include ethenyl, propenyl, butenyl, 1-methyl-2-buten-1-yl, allyl, 1,3-butadienyl, and allenyl. Non-limiting examples of alkynyl groups include ethynyl, 2-propynyl, and 1-propynyl. As “alkene” refers to the compound or moiety H—R, wherein R is an alkenyl.

As used herein, the terms “cycloaliphatic,” “carbocycle,” or “carbocyclic” refer to a saturated or partially unsaturated cyclic aliphatic monocyclic or polycyclic (including fused, bridging and spiro-fused) ring system which has from 3 to 20 carbon atoms. An alicyclic group can optionally have from 3 to 15, optionally from 3 to 12, optionally from 3 to 10, optionally from 3 to 8 carbon atoms, and/or optionally from 3 to 6 carbons atoms. The terms “cycloaliphatic,” “carbocycle,” or “carbocyclic” also include aliphatic rings that are fused to one or more aromatic or nonaromatic rings, such as tetrahydronaphthyl rings, where the point of attachment is on the aliphatic ring. A carbocyclic group may be polycyclic, e.g. bicyclic or tricyclic. It will be appreciated that the alicyclic group can comprise an alicyclic ring bearing one or more linking or non-linking alkyl substituents, such as —CH₂-cyclohexyl. Non-limiting examples of carbocycles include cyclopropane, cyclobutane, cyclopentane, cyclohexane, bicycle[2,2,1]heptane, norborene, phenyl, cyclohexene, naphthalene, spiro[4.5]decane, cycloheptane, adamantine, and cyclooctane.

As used herein, the term “heteroaliphatic group” (including heteroalkyl, heteroalkenyl, and heteroalkynyl) refers to an aliphatic group as defined above, which additionally contains one or more heteroatoms. Heteroaliphatic groups can optionally contain from 2 to 21 atoms, optionally from 2 to 16 atoms, optionally from 2 to 13 atoms, optionally from 2 to 11 atoms, optionally from 2 to 9 atoms, and/or optionally from 2 to 7 atoms, wherein at least one atom is a carbon atom. Non-limiting examples of heteroatoms include O, S, N, P and Si. Where heteroaliphatic groups have two or more heteroatoms, the heteroatoms can be the same or different. Heteroaliphatic groups may be substituted or unsubstituted, branched or unbranched, cyclic or acyclic, and include saturated, unsaturated or partially unsaturated groups.

As used herein, the term “alicyclic group” refers to a saturated or partially unsaturated cyclic aliphatic monocyclic or polycyclic (including fused, bridging and spiro-fused) ring system which has from 3 to 20 carbon atoms. An alicyclic group can optionally have from 3 to 15, optionally from 3 to 12, optionally from 3 to 10, optionally from 3 to 8 carbon atoms, and/or optionally from 3 to 6 carbons atoms. The term “alicyclic” includes cycloalkyl, cycloalkenyl, and cycloalkynyl groups. It will be appreciated that the alicyclic group can comprise an alicyclic ring bearing one or more linking or non-linking alkyl substituents, such as —CH₂-cyclohexyl. Specifically, examples of the C_{3.2}O cycloalkyl group include cyclopropyl, cyclobutyl, cyclopentyl, cyclohexyl, cycloheptyl, adamantyl and cyclooctyl.

As used herein, the term “heteroalicyclic group” refers to an alicyclic group as defined above which has, in addition to carbon atoms, one or more ring heteroatoms, which are optionally selected from O, S, N, P and Si. Heteroalicyclic groups can optionally contain from one to four heteroatoms, which may be the same or different. Heteroalicyclic groups can optionally contain from 5 to 20 atoms, optionally from 5 to 14 atoms, and/or optionally from 5 to 12 atoms.

As used herein, the term “aryl,” “aryl group,” or “aryl ring” refers to a monocyclic or polycyclic ring system having from 5 to 20 carbon atoms, wherein at least one ring in the system is aromatic and wherein each ring in the system contains three to twelve ring members. The term “aryl” can be used alone or as part of a larger moiety as in “aralkyl,” “aralkoxy,” or “aryloxyalkyl.” Non-limiting examples of aryls include phenyl group, methylphenyl, (dimethyl)phenyl, ethylphenyl, biphenyl group, indenyl group, anthracyl group, naphthyl group, or azulenyl group, and the like. The term “aryl groups” includes condensed rings such as indan, benzofuran, phthalimide, phenanthridine, and tetrahydro naphthalene. As “arene” refers to the compound H—R, wherein R is aryl.

As used herein, the term “heteroaryl” used alone or as part of another term (such as “heteroaralkyl”, or “heteroaralkoxy”) refers to a mono- or polycyclic group having from 5 to 14 ring atoms and, in addition to carbon atoms, from one to five heteroatoms. The term “heteroatom” refers to nitrogen, oxygen, or sulfur, and includes any oxidized form of nitrogen or sulfur, and any quaternized form of nitrogen. The term “heteroaryl” also includes groups in which a heteroaryl ring is fused to one or more aryl, cycloaliphatic, or heterocyclyl rings, where the radical or point of attachment is on the heteroaromatic ring. Non-limiting examples of heteroaryls include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, furanyl, imidazolyl, indolyl, indazolyl, methylpyridyl, oxazolyl, pyridyl, pyrrolyl, pyrimidyl, pyrazinyl, quinolyl, quinazolyl, quinoxalinyl, thienyl, triazinyl, and pyrido[2,3-b]-1,4-oxazin-3(4H)-one.

As used herein, the term “aralkyl” refers to an alkyl as previously defined, wherein one of the hydrogen atoms is replaced by an aryl group and/or a heteroaryl group, thus forming a heteroaralkyl, wherein the alkyl, aryl, and/or heteroaryl portions independently are optionally substituted. When used in reference to a ring atom of a heterocycle, the term “nitrogen” includes a substituted nitrogen. Non-limiting examples of aralkyls are: phenylmethyl (benzyl, Bn) and 2-phenyl-ethyl.

Non-limiting examples of alicyclic, heteroalicyclic, aryl and heteroaryl groups include but are not limited to cyclohexyl, phenyl, acridine, benzimidazole, benzofuran, benzothiophene, benzoxazole, benzothiazole, carbazole, cinnoline, dioxin, dioxane, dioxolane, dithiane, dithiazine, dithiazole, dithiolane, furan, imidazole, imidazoline, imidazolidine, indole, indoline, indolizine, indazole, isoindole, isoquinoline, isoxazole, isothiazole, morpholine, napthyridine, oxazole, oxadiazole, oxathiazole, oxathiazolidine, oxazine, oxadiazine, phenazine, phenothiazine, phenoxazine, phthalazine, piperazine, piperidine, pteridine, purine, pyran, pyrazine, pyrazole, pyrazoline, pyrazolidine, pyridazine, pyridine, pyrimidine, pyrrole, pyrrolidine, pyrroline, quinoline, quinoxaline, quinazoline, quinolizine, tetrahydrofuran, tetrazine, tetrazole, thiophene, thiadiazine, thiadiazole, thiatriazole, thiazine, thiazole, thiomorpholine, thianaphthalene, thiopyran, triazine, triazole, and trithiane.

As used herein, the terms “halide”, “halo” and “halogen” are used interchangeably and mean a fluorine atom, a chlorine atom, a bromine atom, an iodine atom and the like, optionally a fluorine atom, a bromine atom or a chlorine atom, and optionally a fluorine atom. The term “haloalkyl” includes fluorinated or chlorinated groups, including perfluorinated compounds. Non-limiting examples of haloalkyls include fluoromethyl group, difluoromethyl group, trifluoromethyl group, fluoroethyl group, difluroethyl group, trifluoroethyl group, chloromethyl group, bromomethyl group, iodomethyl group, and the like.

As used herein, the term “alkaryl” refers to an aryl and/or heteroaryl group as previously defined, wherein one or more of the hydrogen atoms is replaced by an alkyl and/or heteroalkyl group as previously defined.

As used herein, the term “alkoxy” refers to the group —OR, wherein R is an alkyl and/or heteroalkyl as defined herein. Non-limiting examples of alkoxy groups include: —OCH₃, —OCH₂CH₃, —OCH₂CH₂CH₃, —OCH(CH₃)₂, —OCH(CH₂)₂, —OC₃H₆, —OC₄H₈, —OC₅H₁₀, —OC₆H₁₂, —OCH₂C₃H₆, —OCH₂C₄H₈, —OCH₂C₅H₁₀, —OCH₂C₆H₁₂, and the like. Non-limiting examples of alkoxy groups include methoxy group, ethoxy group, n-propoxy group, iso-propoxy group, n-butoxy group, iso-butoxy group, sec-butoxy group, tert-butoxy group, n-pentyloxy group, iso-pentyloxy group, sec-pentyloxy group, n-hexyloxy group, iso-hexyloxy group, n-hexyloxy group, n-heptyloxy group, n-octyloxy group, n-nonyloxy group, n-decyloxy group, n-undecyloxy group, n-dodecyloxy group, n-tridecyloxy group, n-tetradecyloxy group, n-pentadecyloxy group, n-hexadecyloxy group, n-heptadecyloxy group, n-octadecyloxy group, n-nonadecyloxy group, n-eicosyloxy group, 1, 1-dimethylpropoxy group, 1,2-dimethylpropoxy group, 2,2-dimethylpropoxy group, 2-methylbutoxy group, 1-ethyl-2-methylpropoxy group, 1, 1,2-trimethylpropoxy group, 1, 1-dimethylbutoxy group, 1,2-dimethylbutoxy group, 2,2-dimethylbutoxy group, 2,3-dimethylbutoxy group, 1,3-dimethylbutoxy group, 2-ethylbutoxy group, 2-methylpentyloxy group, 3-methylpentyloxy group, and the like.

As used herein, the terms “alkenyloxy”, “alkynyloxy”, “aryloxy”, “aralkoxy”, “heteroaryloxy”, and “acyloxy” refer to groups, defined as —OR, in which R is alkenyl, alkynyl, aryl, aralkyl, heteroaryl, and acyl, respectively. Examples include without limitation aryloxy groups such as —O-Ph and aralkoxy groups such as —OCH₂—Ph (—OBn) and —OCH₂CH₂-Ph.

As used herein, the term “optionally substituted” means that one or more of the hydrogen atoms in the optionally substituted moiety is replaced by a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are optionally those that result in the formation of stable compounds. Non-limiting examples of substituents for use in the present invention include halogen, hydroxy, nitro, carboxylate, carbonate, alkoxy, aryloxy, alkylthio, arylthio, heteroaryloxy, alkylaryl, amino, amido, imine, nitrile, silyl, silyl ether, ester, sulfoxide, sulfonyl, acetylide, phosphinate, sulfonate or optionally substituted aliphatic, heteroaliphatic, alicyclic, heteroalicyclic, aryl or heteroaryl groups (for example, optionally substituted by halogen, hydroxy, nitro, carbonate, alkoxy, aryloxy, alkylthio, arylthio, amino, imine, nitrile, silyl, sulfoxide, sulfonyl, phosphinate, sulfonate or acetylide), and the like.

Embodiments of the present disclosure describe degradable polyethers with a controllable or tunable content of degradable linkages incorporated therein. In some embodiments, the degradable polyethers are be prepared as random copolymers in which ester units or carbonate units are randomly incorporated into a polyether backbone. For example, the degradable polyethers can comprise ester units derived from a cyclic ester such as lactide or carbonate units derived from carbon dioxide incorporated into a poly(ethylene oxide) backbone. Non-limiting examples of such degradable polyethers include poly(ethylene oxide-co-lactide), poly(ethylene oxide-co-ethyl carbonate), and the like. The degradable polyethers can also be prepared as difunctional or hetero-difunctional copolymers, wherein the terminal ends of the degradable polyethers can have functional groups suitable for biological conjugation and application. In other embodiments, the degradable polyethers are prepared as star polymers in which carbonate units or ester units are incorporated into a multifunctional core having polyether arms attached thereto. A non-limiting example of such a degradable polyether includes poly(ethylene oxide) homostars attached to a degradable polycarbonate core.

In some embodiments, the polymer backbone includes poly(ethylene oxide). For example, the polymer backbone can be a poly(ethylene oxide) backbone, which can be linear or branched, substituted or unsubstituted, and functionalized or non-functionalized. In an embodiment, the poly(ethylene oxide) backbone can generally be represented by the following chemical formula:

(—CR₂—CR₂—O—)ₙ

wherein each R is independently selected from hydrogen, alkyls, heteroalkyls, cycloalkyls, alkenyls, heteroalkenyls, cycloalkenes, alkynyls, heteroalkynyls, cycloalkynyls, alkoxys, aryls, heteroaryls, aralkyls, aralkylenes, alkaryls, alkarylenes, halogens, or combinations thereof, each of which can be substituted or unsubstituted, functionalized or non-functionalized; wherein n is at least 1. In an embodiment, the poly(ethylene oxide) backbone is a functionalized linear poly(ethylene oxide). In an embodiment, the poly(ethylene oxide) backbone is a functionalized branched poly(ethylene oxide).

The ester units derived from the cyclic ester or carbonate units derived from carbon dioxide can be incorporated (e.g., randomly incorporated) into the poly(ethylene oxide) backbone or into a multifunctional core of the degradable polyether (e.g., poly(ethylene oxide) homostar). As used herein, the term “ester unit” refers to any segment of the copolymer comprising at least an ester group (e.g., —RC(═O)OR′—). For example, in an embodiment, an ester unit can comprise one or more adjacent lactide units (e.g., L-lactide units), wherein the lactide unit is represented by the following chemical structure:

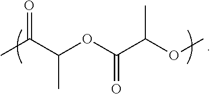

The term “carbonate unit” refers to any segment of the copolymer comprising at least one carbonate group (e.g., —ROC(═O)OR′—). For example, in an embodiment, a carbonate unit can comprise one or more adjacent monoethyl carbonate units, wherein the monoethyl carbonate unit is represented by the following chemical structure:

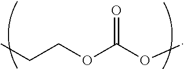

In one embodiment, the degradable polyether can be represented by the following chemical structure:

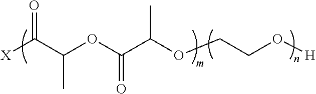

wherein m<n or m<<n; wherein X is selected from Cl, Br, N₃, OH, O—, CH₂═CHCH₂O—, or combinations thereof. In one embodiment, the degradable polyether can be represented by the following chemical structure:

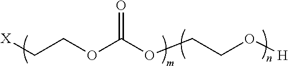

wherein m<n or m<<n; wherein X is selected from Cl, Br, N₃, OH, O—, CH₂═CHCH₂O—, or combinations thereof. In one embodiment, the core of degradable polyether can be represented by the following chemical structure:

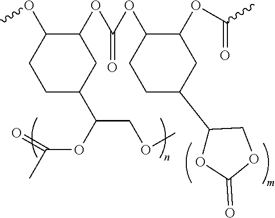

These are provided as examples and thus shall not be limiting as other degradable polyethers are within the scope of the present invention.

The content of the ester units and carbonate units incorporated into the copolymer and multifunctional core is highly tunable, thereby permitting control over the properties and characteristics of the resulting degradable polyether. For example, the poly(ethylene oxide) backbone can be incorporated with a very low to moderate content of ester units or carbonate units sufficient to impart degradable properties to the copolymer, or in the case of some polyether stars, a moderate to high content of ester units and/or carbonate units can be present in the multifunctional core. In some embodiments, the ester units and/or carbonate units can be incorporated without modifying or by retaining the intrinsic properties of either monomer. In one embodiment, the content of ester units and/or carbonate units is very low, for example, about 3% to about 5%. In other embodiments, the ester content and/or carbonate content of the degradable polyether can be about 20% or less. For example, the ester content and/or carbonate content can be about 20% or less, about 19% or less, about 18% or less, about 17% or less, about 16% or less, about 15% or less, about 14% or less, about 13% or less, about 12% or less, about 11% or less, about 10% or less, about 9% or less, about 8% or less, about 7% or less, about 6% or less, about 5% or less, about 4% or less, about 3% or less, about 2% or less, about 1% or less, about 0.5% or less, or about 0.1% or less, or any increment thereof. In other embodiments, such as in the case of star polymers, the ester and/or carbonate content can be at least about 70% or greater. For example, the ester content and/or carbonate content can be about 85%, about 88%, about 89%, or about 90%, or any value or range between 70% and 100%.

The average length of the ester units and carbonate units incorporated into the copolymer and/or multifunctional core can also be tuned. The average length of ester units can refer to the average number of adjacent ester groups found along the copolymer backbone and/or in the multifunctional core, within each ester unit. The average length of carbonate units can refer to the average number of adjacent carbonate groups found along the copolymer backbone and/or in the multifunctional core, within each carbonate unit. The units can be measured in terms of groups, such as ester groups and/or carbonate groups, or it can be measured in terms of the monomers, such as lactides and/or carbonates. For example, in one embodiment, the average length of the ester units and carbonate units found along the copolymer backbone can be about 2 lactides or less and about 2 monoethyl carbonates or less, respectively. In other embodiments, the average length of the ester units and carbonate units found along the copolymer backbone can be about 10 or less. For example, the average length of the ester units and carbonate units can be about 10 or less, about 9 or less, about 8 or less, about 7 or less, about 6 or less, about 5 or less, about 4 or less, about 3 or less, about 2 or less, or about 1.

One or more of the terminal ends of the degradable polyether can have functional groups to allow conjugation of biologically active molecules with the poly(ethylene oxide). The functional group can be selected based on the target molecule with which the degradable polyether is to be conjugated. In an embodiment, the functional groups can be selected from halogen-, ester-, acid-, azide-, hydroxyl-, amino-, vinyl-containing end groups, and combinations thereof. For example, the functional groups can be selected from Cl, Br, N₃, OH, O—, CH₂═CHCH₂O—, and combinations thereof. Suitable biologically active molecules include, but are not limited to, proteins, peptides, enzymes, medicinal chemicals or organic moieties, and combinations thereof.

The degradable polyethers can be well-defined and have a molar mass ranging from about greater than 0 kg/mol to about 50 kg/mol, even up to about 850 kg/mol. In one embodiment, the molar mass of the degradable polyether is about 24 kg/mol or less. In some embodiments, the molar mass of the degradable polymers can be about 50 kg/mol, about 35 kg/mol or less, about 30 kg/mol or less, about 25 kg/mol or less, about 24 kg/mol or less, about 23 kg/mol or less, about 22 kg/mol or less, about 21 kg/mol or less, about 20 kg/mol or less, about 19 kg/mol or less, about 18 kg/mol or less, about 17 kg/mol or less, about 16 kg/mol or less, about 15 kg/mol or less, about 14 kg/mol or less, about 13 kg/mol or less, about 12 kg/mol or less, about 11 kg/mol or less, about 10 kg/mol or less, about 9 kg/mol or less, about 8 kg/mol or less, about 7 kg/mol or less, about 6 kg/mol or less, about 5 kg/mol or less, about 4 kg/mol or less, about 3 kg/mol or less, about 2 kg/mol or less, or about 1 kg/mol or less. In other embodiments, the molar mass of the degradable polyether star is about 850 kg/mol or less, or any value or range between 0 kg/mol and 850 kg/mol.

The degradable polyethers can also have narrow polydispersity. In an embodiment, the polydispersity index of the degradable polyethers can range from about 1 to about 1.6. For example, the polydispersity index of the degradable polyethers can be about 1.6, about 1.5, about 1.4, about 1.30, about 1.29, about 1.28, about 1.27, about 1.26, about 1.25, about 1.24, about 1.23, about 1.22, about 1.21, about 1.20, about 1.19, about 1.18, about 1.17, about 1.16, about 1.15, about 1.14, about 1.13, about 1.12, about 1.11, about 1.10, about 1.09, about 1.08, about 1.07, about 1.06, about 1.05, about 1.04, about 1.03, about 1.02, about 1.01, or about 1.00.

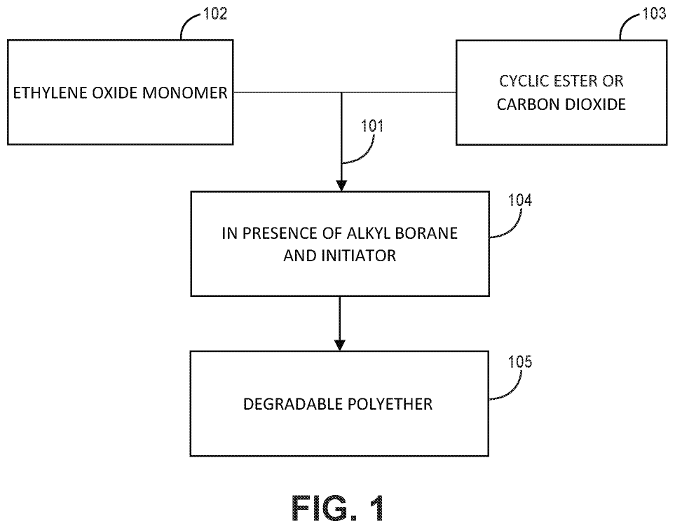

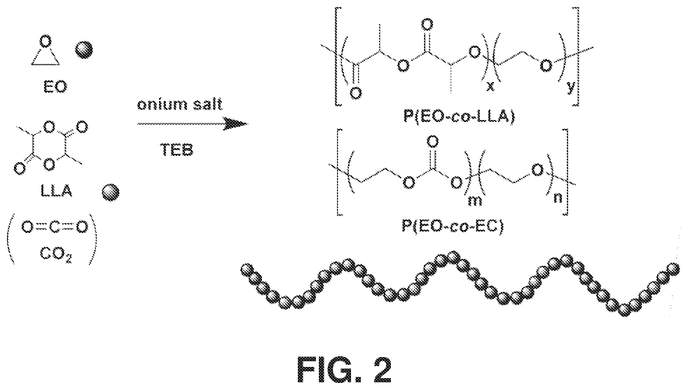

FIG. 1 is a flowchart of a method of forming a degradable polyether by anionic ring opening copolymerization, according to one or more embodiments of the present disclosure. As shown in FIG. 1, the methods 100 can proceed by contacting 101 an ethylene oxide monomer 102 with a cyclic ester or carbon dioxide 103 in the presence of an alkyl borane and an initiator 104 to form a polyether 105 having degradable carbonate linkages or degradable ester linkages incorporated into the polymer backbone. A schematic diagram of a reaction scheme in which a degradable polyether is formed is shown in FIG. 2.

The contacting generally proceeds by bringing the ethylene oxide monomer, cyclic ester, carbon dioxide, alkyl borane, and/or initiator into physical contact, or immediate or close proximity. The contacting of each component or species can proceed simultaneously or sequentially, in any order, and thus is not particularly limited. Each of the species can be contacted in a solvent, such as apolar solvents or slightly polar solvents. For example, in an embodiment, the solvent can be selected from toluene and tetrahydrofuran, among other such solvents. The contacting can proceed at temperatures in the range of about 0° C. to about 100° C., or any value or range thereof. Preferably the contacting proceeds at about room temperature, such as temperatures in the range of about 20° C. to about 30° C. The duration of the contacting should be sufficient to carry out the copolymerization reaction. For example, the duration of the contacting can range from about 1 min to about 1000 min, or longer in some instances.

In embodiments involving cyclic esters such as lactide, the activator and initiator can optionally be contacted separately from the ethylene oxide monomer and cyclic ester. For example, in an embodiment, the activator and initiator can be contacted in a solvent to form a first solution, and the ethylene oxide monomer and cyclic ester can be contacted separately in a solvent to form a second solution. The first solution and the second solution can then be contacted, optionally under stirring, and the reaction allowed to proceed. In embodiments in which the initiator has two components, the initiator can optionally be formed prior to being contacted with the activator. For example, in an embodiment, initiator precursor species can be contacted in a solvent to form the initiator and then the initiator can be contacted with the activator in a solvent to form the first solution. In embodiments involving carbon dioxide, the initiator and carbon dioxide can optionally be contacted and then dissolved in a solvent to form a first solution, and the activator can be contacted with a solvent to form a second solution. The first solution and second solution can then be contacted and thereafter the ethylene oxide monomer can be added and the reaction allowed to proceed (e.g., under 1 bar of carbon dioxide).

The molar ratio of the ethylene oxide monomer to cyclic ester or carbon dioxide can be selected or adjusted to achieve degradable polyethers with varying (and tunable) content of ester units or carbonate units at select or desired lengths. Typically, the ethylene oxide monomer is added in stoichiometric excess of the cyclic ester or carbon dioxide. For example, the molar ratio of the ethylene oxide monomer to the cyclic ester can range from about 1.01:1 to about 10:1. In an embodiment, the molar ratio can be about 2:1, about 3:1, about 4:1, about 5:1, about 6:1, about 7:1, about 8:1, about 9:1, about 10:1, or any increment between those ratios.

Suitable ethylene oxide monomers include monomers of the formula:

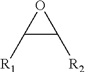

wherein each of R₁ and R₂ can be independently selected from nothing, hydrogen, alkyls, heteroalkyls, cycloalkyls, alkenyls, heteroalkenyls, cycloalkenes, alkynyls, heteroalkynyls, cycloalkynyls, alkoxys, aryls, heteroaryls, aralkyls, aralkylenes, alkaryls, alkarylenes, halogens, or combinations thereof, each of which can be substituted or unsubstituted. In some embodiments, R₁ and R₂ connect to form a fused ring having, for example, five or more carbon atoms in the ring structure, where any of the carbon atoms can optionally be replaced with a heteroatom. Non-limiting examples of suitable ethylene oxide monomers include:

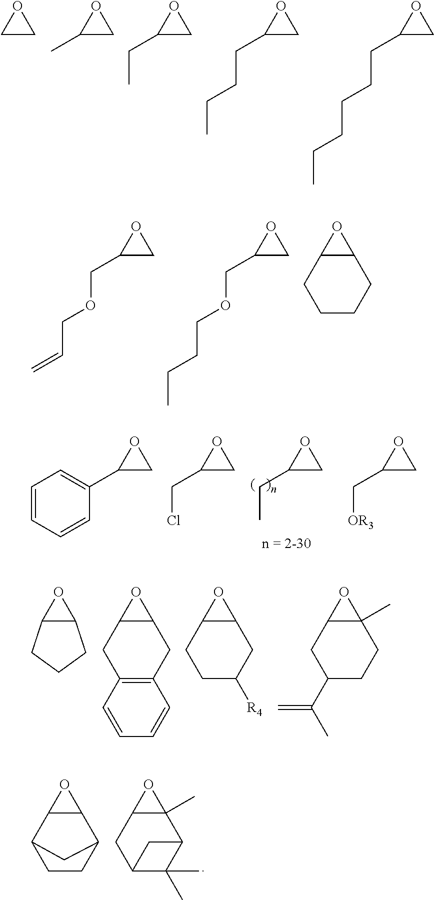

These shall not be limiting as other ethylene oxide monomers can be utilized herein without departing from the scope of the present disclosure. In some embodiments, R₁ and/or R₂ comprise one or more additional ethylene oxide monomers. For example, in some embodiments, the ethylene oxide monomer can be characterized as diepoxide monomers, triepoxide monomers, etc.

The cyclic ester can be selected from any cyclic compound (e.g., cycloalkanes, cycloalkenes, etc.) having one or more carbon atoms replaced by an ester unit/group of the formula —C(O)O—. Suitable cyclic esters include, but are not limited to, cyclic monoesters, cyclic diesters, cyclic triesters, and the like. Non-limiting examples of suitable cyclic esters include lactide, trimethylene carbonate, glycolide, β-butyrolactone, 6-valerolactone, γ-butyrolactone, γ-valerolactone, 4-methyldihydro-2(3H)-furanone, alpha-methyl-gamma-butyrolactone, ε-caprolactone, 1,3-dioxolan-2-one, propylene carbonate, 4-methyl-1,3-dioxan-2-one, 1,3-doxepan-2-one, 5-C₁₋₄alkoxy-1,3-dioxan-2-one; and mixtures or derivatives thereof; any one of which can be unsubstituted or substituted. In preferred embodiments, the cyclic ester includes a lactide monomer. The lactide monomers can be selected from L-lactide, D-lactide, meso-lactide, and combinations thereof. The lactide monomers can further be substituted or unsubstituted. For example, the methyl groups of lactide can be replaced with one or more substituents selected from hydrogen, alkyls, heteroalkyls, cycloalkyls, alkenyls, heteroalkenyls, cycloalkenes, alkynyls, heteroalkynyls, cycloalkynyls, alkoxys, aryls, heteroaryls, aralkyls, aralkylenes, alkaryls, alkarylenes, halogens, or combinations thereof, each of which can be substituted or unsubstituted. The aforementioned substituents shall not be limiting as any substituent known in the art can be used herein.

The activator can be selected to achieve one or more of the following: selectively activate the ethylene oxide monomer, form an ate complex with the initiator, suppress transesterification reactions, and suppress the formation of cyclic carbonates. The alkyl borane is typically provided in stoichiometric excess of the initiator. In one embodiment, a ratio of the alkyl borane to initiator can be about 5:1. In some embodiments, the ratio of the alkyl borane to initiator is in the range of about 1:1 to about 5:1. In other embodiments, a ratio of the alkyl borane to initiator can be about 2:1, about 3:1, about 4:1, about 5:1, about 6:1, about 7:1, about 8:1, about 9:1, about 10:1, or even greater. The activator used in the methods described herein can be an alkyl borane, such as a trialkyl borane. Non-limiting examples of suitable activators include triethyl borane, triphenyl borane, tributylborane, trimethyl borane, triisobutylborane, and combinations thereof. In certain embodiments, the alkyl borane is triethyl borane.

The initiator, which forms an ate complex with the activator, can include salts or organic bases. The salts and organic bases can include organic cations or alkali metals associated or mixed with anions. For example, in an embodiment, the initiator includes an organic cation associated or mixed with an alkoxide having an organic substituent. In an embodiment, the initiator includes an alkali metal associated or mixed with an alkoxide having an organic substituent. In an embodiment, the initiator includes an organic cation associated or mixed with an azide. In an embodiment, the initiator includes an organic cation associated or mixed with a halogen.

The organic cations can be based on one or more of phosphazenium, ammonium, and phosphonium. For example, in an embodiment, the organic cation can be based on phosphazene bases, such as t-Bu-P_{Y}, where Y is 2 or 4; or ammonium salts or phosphonium salts, wherein the nitrogen or phosphorous thereof is connected to four alkyl groups, each of which can be the same or different. The alkali metal can include any alkali metal. For example, in an embodiment, the alkali metals can be selected from lithium, potassium, sodium, and combinations thereof. The anions can include any negatively charged species. For example, in an embodiment, the anions can be selected from hydroxyls, esters, acids, alkoxides, azides, and halogens. The alkoxides can be formed from any alcohol having at least one hydroxyl group. Any halogen can be used. For example, in an embodiment, the halogen can be selected from Cl⁻ and Br⁻.

In an embodiment, the initiator can be selected from the following chemical formulas:

{Y⁺,RO⁻},{Y⁺,RCOO⁻},{X⁺,N₃⁻}, and {X⁺,Cl⁻};

wherein Y⁺ is selected from K⁺, t-BuP₄⁺, and t-BuP₂⁺; wherein X⁺ is selected from NBu₄⁺, PBu₄⁺, NOct₄⁺, and PPN⁺; wherein RO⁻ is selected from CH₃O(CH₂)₂O(CH₂)₂O—, H₂C═CHCH₂O⁻,

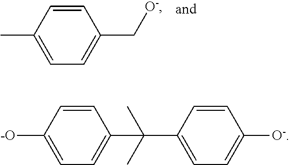

For example, the initiator can be selected and/or prepared from p-methyl benzyl alcohol (PMBA) and t-BuP₄, diethylene glycol monomethyl ether (DGME) and t-BuP₄, bisphenol A (BPA) and t-BuP₄, p-methyl benzyl alcohol (PMBA) and t-BuP₂, tetra butyl ammonium chloride (TBAC), bis(triphenylphosphine)iminium chloride (PPNCl), tetra octyl ammonium chloride (TOACl), tetra butyl phosphonium chloride (TBPCl), tetra butyl ammonium azide (TBAA), and Allyl alcohol and t-BuP₄.

In one embodiment, the method of forming a degradable polyether can proceed as shown in the following reaction scheme:

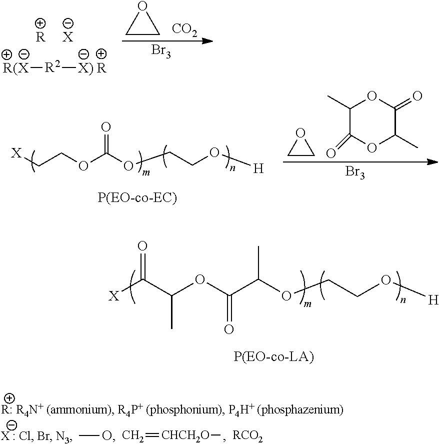

In one embodiment, the method of forming a degradable polyether can proceed as shown in the following reaction scheme:

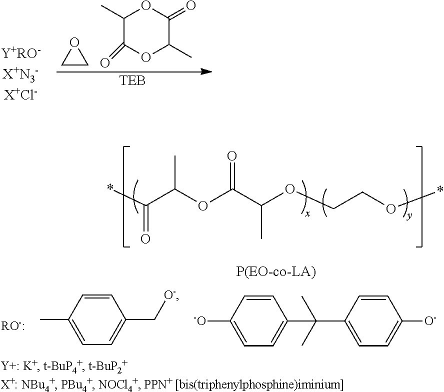

Embodiments of the present disclosure further describe modified biological molecules comprising a biologically active molecule conjugated with a degradable polyether having ester units or carbonate units incorporated into a poly(ethylene oxide) backbone. Typically, the biologically active molecule is modified through covalent conjugation with the degradable polyether. The biologically active molecule can be selected from proteins, peptides, enzymes, medicinal chemicals or organic moieties, and combinations thereof. The degradable polyether can comprise any of the copolymers of the present disclosure.

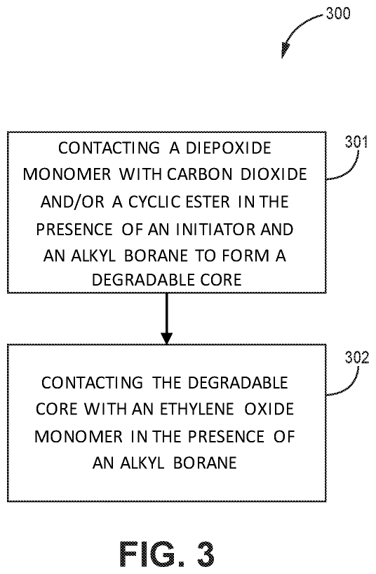

FIG. 3 is a flowchart of a method of forming a degradable polyether star, according to one or more embodiments of the present disclosure. As shown in FIG. 3, the method 300 can proceed by contacting 301 a diepoxide monomer with carbon dioxide and/or a cyclic ester, in the presence of an initiator and a first amount of an alkyl borane. In this step, the diepoxide monomer can copolymerize, e.g., by anionic ring-opening copolymerization, with the carbon dioxide and/or cyclic ester to yield a multifunctional core comprising carbonate units and/or ester units. For example, the carbonate units can be derived from the carbon dioxide, yielding degradable carbonate linkages. The ester units can be derived from the cyclic ester, yielding degradable ester linkages. The presence of the carbonate units and/or ester units can depart degradability to the resulting multifunctional core. Examples of such multifunctional cores include, but are not limited to, polycarbonate cores, polyether cores, polyester cores, and the like.

The contacting 301 can proceed by sequentially or simultaneously adding, in any order, the initiator, a solvent, alkyl borane, diepoxide monomer, carbon dioxide, and/or cyclic ester to a reaction vessel, which can optionally proceed under mechanical stirring. For example, in some embodiments, a suitable preparation sequence includes sequentially adding the initiator to the reaction vessel, followed by the sequential addition of the solvent, alkyl borane, and diepoxide monomer, with or without mechanical stirring. Upon adding one or more of the foregoing components, carbon dioxide or the cyclic ester can be introduced into the reaction vessel and the copolymerization reaction can be allowed to proceed. During or through the copolymerization reaction, the epoxide rings of the diepoxide monomer can ring open and each can copolymerize with carbon dioxide and/or the cyclic ester in the presence of the initiator and alkyl borane. In this way, the diepoxide monomer can serve as crosslinker, linking at least two polymer chains, each being formed through the copolymerization.

Suitable initiators, solvents, and/or alkyl boranes are described above and thus not repeated here. The diepoxide monomer can be selected from any monomer comprising at least two epoxides. An example of a suitable diepoxide monomer include vinyl cyclohexene dioxide and its derivatives. Other suitable diepoxide monomers include, but are not limited to, butadiene dioxide; 1,2,3,4-diepoxybutane; 1,2,7,8-diepoxyoctane; 1,2,5,6-diepoxycyclooctane; dicylopentadiene diepoxide; poly(ethylene glycol diglycidal); diglycidyl ethers such as glycerol diglycidal as well as diglycidyl ethers of such compounds as 1,3-propanediol, 1,4-butanediol, 1,6-hexandiol, cyclohexane-1,4-diol, cyclohexane-1,1-dimethanol, cyclohexane-1,2-dimethanol, cyclohexane-1,3-dimethanol, cyclohexane-1,4-dimethanol, diethylene glycol, hydroquinone, resorcinol, 4,4-isopropylidenebisphenol, naphthalene diols, and the like; or derivatives thereof. While diepoxide monomers are described, other multifunctional epoxides can be utilized herein, including, for example, triepoxides, and the like.

The extent or degree of crosslinking may affect the degradability of the resulting multifunctional core. For example, while it can depend on the selection of the reagents and reaction conditions, among other things, a high degree of crosslinking may not yield degradable multifunctional cores but form a gel. Accordingly, in carrying out the copolymerization, it may be desirable for the extent or degree of crosslinking of the diepoxide monomer to be kept or maintained at a low to moderate level. This can be achieved, for example, by using low to moderate amounts of the diepoxide monomer. For example, in some embodiments, the molar ratio of diepoxide monomer to initiator is kept below about 10, but no greater than about 20. For example, the molar ratio of diepoxide monomer to initiator can be about 20 or less, about 19 or less, about 18 or less, about 17 or less, about 16 or less, about 15 or less, about 14 or less, about 13 or less, about 12 or less, about 11 or less, preferably about 10 or less, or about 9 or less, about 8 or less, about 7 or less, about 6 or less, or more preferably about 5 or less, or about 4 or less, about 3 or less, or about 2 or less, or any value or range thereof.

The volumetric ratio of diepoxide monomer to solvent can be in the range of about 1:1 to about 1:10. For example, in some embodiments, the volumetric ratio of diepoxide monomer to solvent is about 1:1, about 1:1.5, about 1:2, about 1:2.5, about 1:3, about 1:3.5, about 1:4, about 1:4.5, about 1:5, about 1:5.5, about 1:6, about 1:6.5, about 1:7, about 1:7.5, about 1:8, about 1:8.5, about 1:9, about 1:9.5, or about 1:10, or any range therebetween or value thereof.

The carbon dioxide can be charged to the reaction vessel at pressures in the range of about 0.01 bar to about 25 bar. For example, in some embodiments, the carbon dioxide can be charged at pressures in the range of about 5 bar to about 15 bar, preferably about 10 bar. In other embodiments, the carbon dioxide is charged at a pressure of about 1 bar, about 2 bar, about 3 bar, about 4 bar, about 5 bar, about 6 bar, about 7 bar, about 8 bar, about 9 bar, about 10 bar, about 11 bar, about 12 bar, about 13 bar, about 14 bar, about 15 bar, about 16 bar, about 17 bar, about 18 bar, about 19 bar, about 20 bar, about 21 bar, about 22 bar, about 23 bar, about 24 bar, or about 25 bar, or any value or range thereof.

The temperatures at or under which step 301 is performed can be in the range of about 0° C. to about 100° C. In some embodiments, the contacting proceeds at a temperature in the range of about 50° C. to about 80° C. For example, the contacting can proceed at a temperature of about 50° C., about 51° C., about 52° C., about 53° C., about 54° C., about 55° C., about 56° C., about 57° C., about 58° C., about 59° C., about 60° C., about 61° C., about 62° C., about 63° C. about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., or about 80° C., or any value therebetween or range thereof. In addition, the contacting can proceed for durations of about a week or less, preferably less than about 24 h, or more preferably less than about 17 h, such as about 15 h.

Upon forming the multifunctional core in step 301 and optionally cooling of the reaction vessel, the arms of the degradable polyether star can be polymerized. Accordingly, at step 302, the degradable multifunctional core from step 301 is contacted with an ethylene oxide monomer in the presence of a second amount of the alkyl borane. The ethylene oxide monomer is polymerized in the ensuing reaction, yielding arms of a polyether attached to the degradable multifunctional core, thereby forming the degradable polyether star. In some embodiments, the arms of the polyether star are chemically identical, thereby affording homostars. In some embodiments, two or more ethylene oxide monomers can be reacted, or monomers other than ethylene oxide monomers can be reacted, to afford heterostars with different arms, or stars with arms comprising copolymers (e.g., block copolymers), among other types of polymers.

To form the arms of the polyether star, the ethylene oxide monomer can be added to the reaction vessel. Suitable ethylene oxide monomers are described above and thus not repeated here. In some embodiments, a solution comprising the ethylene oxide monomer, solvent, and the second amount of alkyl borane are injected into the reaction vessel, following the purging or release of unreacted carbon dioxide. In embodiments involving cyclic esters, the reaction in step 301 can be allowed to proceed until full or complete consumption of the cyclic ester is obtained, or unreacted cyclic ester can be separated and/or removed from the reaction vessel. Upon the addition of the ethylene oxide monomer, solvent, and second amount of alkyl borane, the polymerization can be allowed to proceed, optionally under mechanical stirring, to form the polyether arms of the star polymer.

The volumetric ratio of ethylene oxide monomer to solvent can be in the range of about 1:1 to about 1:20. For example, in some embodiments, the volumetric ratio of ethylene oxide monomer to solvent is about 1:1, about 1:2, about 1:3, about 1:4, about 1:5, about 1:6, about 1:7, about 1:8, about 1:9, about 1:10, about 1:11, about 1:12, about 1:13, about 1:14, about 1:15, about 1:16, about 1:17, about 1:18, about 1:19, or about 1:20, preferably about 1:5 to about 1:15, or more preferably about 1:10.

Although not required, in some embodiments, the alkyl borane added in step 301 of the present method is added to the reaction vessel in stoichiometric quantities with the initiator, each of which react to form an ate complex that can be utilized to activate the copolymerization in step 301. In some instances, a second amount of the alkyl borane in step 302 can be added to the reaction vessel such that the alkyl borane is present in stoichiometric excess to activate the ethylene oxide and ring-open polymerization. In some embodiments, the excess alkyl borane may be utilized to activate the ethylene oxide monomer in the polymerization of the polyether arms. In some embodiments, the first amount and second amount of the alkyl borane is the same. In some embodiments, the first amount and the second amount of the alkyl borane is different. For example, in some embodiments, the first amount of the alkyl borane is less than the second amount. In some embodiments, the first amount of the alkyl borane is greater than the second amount.

In some embodiments, either at the time of contacting 302 or throughout the polymerization of the ethylene oxide monomer, or both, the molar ratio of the multifunctional core to alkyl borane can be selected or maintained at a molar ratio in the range of about 1:1 to about 1:10. For example, in some embodiments, the molar ratio of the multifunctional core to alkyl borane is selected or maintained at about 1:1, about 1:1.5, about 1:2, about 1:2.5, about 1:3, about 1:3.5, about 1:4, about 1:4.5, about 1:5, about 1:5.5, about 1:6, about 1:6.5, about 1:7, about 1:7.5, about 1:8, about 1:8.5, about 1:9, about 1:9.5, or about 1:10, or any value or range thereof. Preferably, the molar ratio of the diepoxide monomer to alkyl borane is in the range of about 1:3 to about 1:5, or any value thereof, more preferably about 1:3.

The temperatures at or under which step 302 is performed can be in the range of about 0° C. to about 100° C. In some embodiments, the contacting proceeds at a temperature in the range of about 30° C. to about 50° C. For example, the contacting can proceed at a temperature of about 30° C., about 31° C., about 32° C., about 33° C., about 34° C., about 35° C., about 36° C., about 37° C., about 38° C., about 39° C., about 40° C., about 41° C., about 42° C., about 43° C. about 44° C., about 45° C., about 46° C., about 47° C., about 48° C., about 49° C., or about 50° C., or any value therebetween or range thereof. Preferably, the polymerization reaction is carried out at a temperature of about 40° C. In addition, the contacting can proceed for durations of about a week or less, preferably about 24 h or less.

In further step 303 (not shown), the reaction mixture from step 302 can be quenched using an acid, such as HCl, in an alcohol, such as methanol. To obtain the fine product, the crude product can be dissolved and/or precipitated in diethyl ether, and then centrifuged and dried.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### Example 1

### Degradable Poly(Ethylene Oxide) Through Anionic Copolymerization of Ethylene Oxide with L-Lactide

The following Example describes a simple and convenient method for the preparation of degradable poly(ethylene oxide) (PEO). Through anionic copolymerization of ethylene oxide and L-Lactide (LLA), a very low content of LLA was randomly incorporated into the backbone of PEO in the presence of triethylborane. With the help of the latter Lewis acid, the reactivity of LLA was curtailed, and transesterification reactions were suppressed. The copolymerization of EO with LLA resulted in P(EO-co-LLA) samples with low to moderate content in ester units, controlled molar mass, and narrow polydispersity. Reactivity ratios were determined using Kelen-Tüdos and Meyer-Lowry terminal model methods. The resulting copolymers were further studied by differential scanning calorimetry (DSC); hydrolysis experiments were carried out to show the degradability of these PEO samples.

The objective of the work presented in this Example was to incorporate a low to very low percentage of LLA units within PEO chains by anionic copolymerization of EO with LLA, in order to impart degradability to these PEO chains without modifying their intrinsic properties of hydrophilicity, crystallinity, etc. The role of triethylborane in the anionic copolymerization of EO with LLA was particularly studied. Unlike the coordinative catalytic pathway that affords LLA-EO copolymers of broad molar mass distribution and generally ill-defined, the boron-activated anionic copolymerization of EO and LLA produced well-defined P(EO-co-LLA) samples exhibiting narrow polydispersity and a tunable content of EO and LLA units (see scheme below). The scheme presented below illustrates a reaction scheme of an anionic ring-opening polymerization of ethylene oxide and L-lactide using triethylborane as activator:

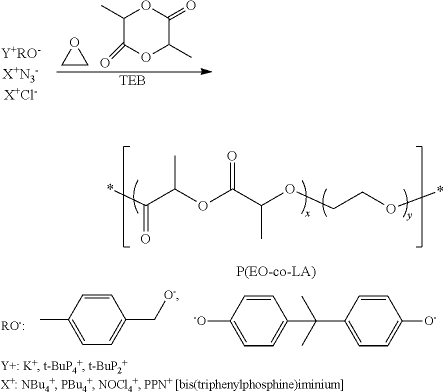

### Experimental Section

### General Methods

All reactions were carried out under a dry and oxygen-free argon atmosphere in a Braun Labmaster glovebox. Ethylene oxide (EO), L-Lactide (LLA), diethylene glycol monomethyl ether, p-methyl benzyl alcohol (PMBA), bisphenol A (BPA), t-BuP₄, t-BuP₂, tetra butyl ammonium chloride (TBACl), Bis(triphenylphosphine)iminium chloride (PPNCl), tetra octyl ammonium chloride (TOACl), tetra butyl phosphonium chloride (TBPCl), tetra butyl ammonium azide (TBAA), Allyl alcohol (Allyl A) were purchased from Aldrich.

Tetrahydrofuran (THF) and toluene (Tol) were distilled over sodium/benzophenone mixture before used. 1,4-dioxane was distilled over CaH₂ after stirring for two days. Ethylene oxide was purified by stirring over CaH₂ for one day and distilled into a flask containing n-BuLi. It was then stirred for a couple of hours, which was followed by further distillation. LLA was purified by two times recrystallization from ethyl acetate followed by lyophilization from dry dioxane. Diethylene glycol monomethyl ether was purified by azeotropic distillation from toluene. PMBA and BPA were lyophilized from dioxane. All ¹H and ¹³C NMR spectra were recorded on a Bruker AVANCE 111-400 Hz instrument in CDCl₃. GPC traces were recorded by VISCOTEK VE2001 equipped with Styragel HR2 THF (1 mL/min) as eluent. Narrow Mw polystyrene standards were used to calibrate the instrument. DSC measurements were performed with a Mettler Toledo DSC1/TC100 under air. The samples were first heated from RT to 200° C. in order to erase the thermal history, then cooled to −100° C., and finally heated again to 200° C. at a heating/cooling rate of 10° C. min⁻¹. This cycle was repeated until constant melting and cooling temperatures (Tₘ and T_{c}) were recorded.

Representative procedure for the synthesis of P(EO-co-LLA) using tetrabutylammonium chloride (TBACl) as initiator: A pre-dried 30 mL glass Schlenk tube tube (80 mm×28 mm) composed of rotaflo stopcocks and equipped with a magnetic stirring bar was used to carry out this reaction. Under argon atmosphere, about 86 μL of triethylborane (about 0.086 mmol) was first added to a solution of TBACl (about 4.8 mg, about 0.017 mmol) in toluene (about 0.5 mL) in the glass Schlenk tube. The premixed solution of LLA (about 100 mg, about 0.69 mmol) and ethylene oxide (about 150 mg, about 3.47 mmol) in about 1 mL of toluene were then added into initiator-borane system. The polymerization was carried out at about room temperature (about 25° C.) for about 4 hours under stirring. Then the reaction was quenched with a few drops of 5% HCl in methanol and the polymer was precipitated in cold diethyl ether. The obtained polymer after filtration was dried in vacuum oven and characterized by GPC and NMR.

Representative procedure for the synthesis of P(EO-co-LLA) using t-BuP4 initiator: A pre-dried 30 mL glass Schlenk tube (80 mm×28 mm) composed of rotaflo stopcocks and equipped with a magnetic stirring bar was used to carry out this reaction. Under argon atmosphere, to a solution of PMBA (about 4.3 mg, about 0.035 mmol) in toluene (about 0.5 mL), t-BuP4 solution (about 35 μL, about 0.035 mmol) was charged into reaction flask, and stirred for a few minutes under about room temperature. Then, triethylborane (about 176 μL, about 0.176 mmol) and the premixed monomer solution of LLA (about 75 mg, about 0.520 mmol) and ethylene oxide (about 152 mg, about 3.47 mmol) in toluene (about 1 mL) were sequentially added into the initiator-borane system and the polymerization was carried out at about room temperature for about 1 hour under stirring. The reaction was quenched with a few drops of 5% HCl in methanol and precipitated in cold diethyl ether. The polymer obtained after filtration was dried in vacuum oven and characterized by GPC and NMR

### Results and Discussion

### Copolymerization of Ethylene Oxide and L-Lactide

Since EO and LLA exhibit very different reactivity and since the monomer unit corresponding to LLA is prone to transesterification reactions under anionic conditions, EO and LLA cannot be copolymerized using even a mild base as initiator. It takes, for instance, about 3 days to complete the polymerization of EO in the presence of an alcohol and a mild base, such as t-BuP₂, whereas only about 1 minute is necessary to achieve the full conversion of LLA under the same conditions. This has been the primary reason for using coordinative chemistry to copolymerize these two monomers.

Catalytic processes which imply a necessary coordination step of the monomer have advantages, such as the production of long chains, but they also have drawbacks, such as chains that are not necessarily well-defined and have broad molar mass distributions. In this Example, a novel approach for the copolymerization of EO with LLA is proposed. The novel approach is based not on purely anionic species, but on an ate complex involving a Lewis acid, namely triethylborane, and a base, which is typically an alkoxide. Ate complexes were used for the successful copolymerization of epoxides and CO₂ without the formation of cyclic carbonates, which are generally obtained by purely ionic species. Likewise boron-based ate complexes were found very efficient for initiating and bringing about a controlled polymerization of glycidyl azide, an epoxide monomer that could never be polymerized before. In each of the two above examples in addition to the boron-based ate complex, free trialkylboron had to be added to activate the monomer for the polymer to occur as the growing ate complex was generally not nucleophilic enough.

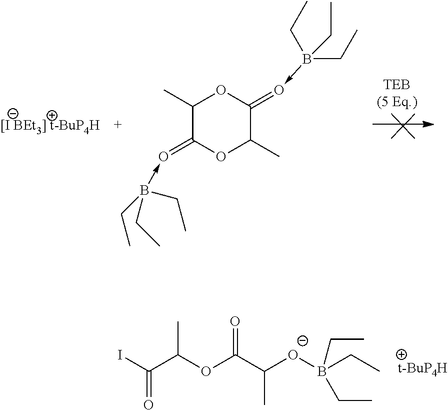

It first attempt was tried to homopolymerize EO and LLA using PMBA/t-BuP4 as the initiator system and TEB as the Lewis acid to form the ate complex responsible for the polymerization. Both homopolymerizations were carried out in the presence of an excess of 5 eq. TEB to activate the monomer. In the case of EO, the homopolymerizations occurred as expected affording samples with the expected molecular weights either in THF or toluene: clearly the presence of free TEB was essential to trigger the polymerization (Entry 1 and 2, Table 1). In contrast, hardly any homopolymerization was observed in the case of LLA (see scheme immediately above), in spite of the presence of 5 eq. of excess of TEB (conversion below 1%) and the addition of further excess of TEB did not help to increase the conversion of LLA (Entry 3 and 4, Table 1).

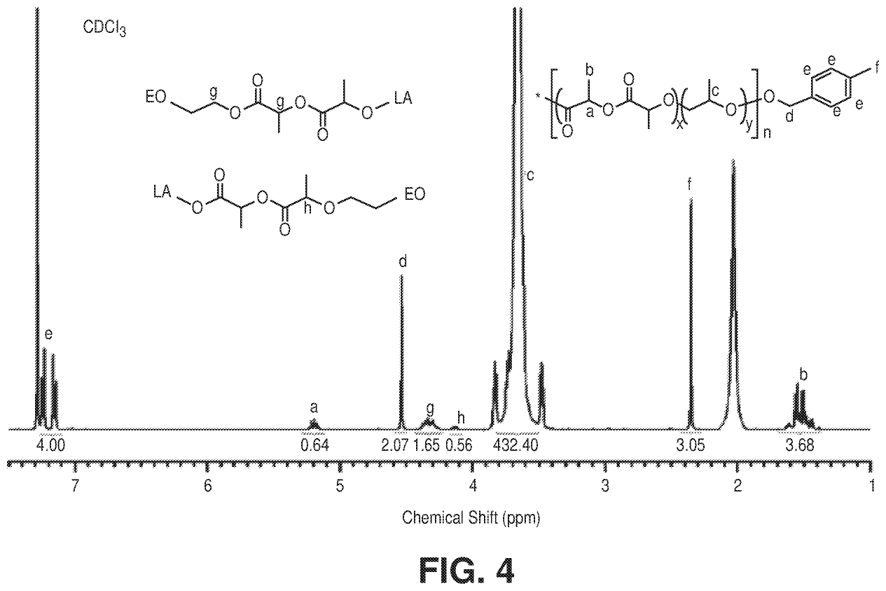

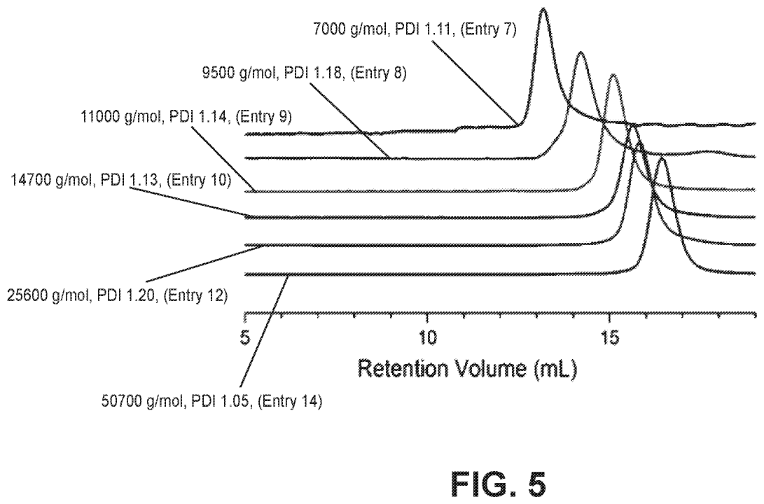

Interestingly, a monomer like LLA, which homopolymerizes very fast when subjected to purely ionic species, stayed “put” in this case and failed to ring-open in the presence of boron-based ate complexes. The copolymerization of LLA with EO in the presence of 5 eq. of TEB was then investigated. About 15-20 mol % of LLA were fed to the reaction medium to see whether a low content of ester could be incorporated into the PEO backbone. In all the following experiments, toluene, an apolar solvent, was used in the copolymerizations of EO with LLA. After polymerization, the reaction mixture was poured in cold ether to collect all the produced polymer and characterized by GPC and NMR. A representative ¹H NMR spectrum is shown in FIG. 4. The characteristic peaks of LLA and of EO units were clearly detected at 5.2 and 1.5 ppm (peaks a, b) and at 3.5 ppm (peak c) indicating the incorporation of the ester units. The peaks g and h at 4.3 ppm and 4.10 ppm, respectively, corresponded to the methylene protons of EO and methine protons of LLA connected between EO and LLA units CH₂CH₂OOCCH(CH₃)OOCCH(CH₃)O—, and to the methine protons of LLA units connected between LLA and EO units —OCCH(CH₃)OOCCH(CH₃)OCH₂CH₂O—, which is shown in FIG. 4. The presence of characteristic and connection peaks of two PEO and PLLA units indicated the formation of a random copolymer. The integral ratio of peak g to h was close to 3, indicating negligible transesterifications of LLA. Based on the NMR data, the content of LLA units could then be calculated and the molar mass of the obtained copolymer estimated using the peaks of initiator p-methylbenzene alcohol (d, e, fat 4.5, 7.1, 2.3 ppm) as reference (please refer to related data listed in Table 1). The average segment length of PLLA was determined to be equal to about 1.57 by the equation LLLA=(SI_{5.21 ppm}+2SI_{4.10 ppm})/2SI_{4.10 ppm}, where SI is the integral intensity of the respective peaks. This meant that, on average, less than 2 units of LLA were found adjacent along the polymer backbone, confirming the very low value of the reactivity ratio of LLA, r_{LLA}. Following the same procedure, the polymerization was initiated by the system PMBA It-BuP₄ in the presence of TEB and different molar masses were targeted (Entry 6-12, Table 1). Values of molar mass obtained from NMR for the various samples were close to the theoretical ones; a molar mass as high as 24 kg/mol was reached and ester contents in all cases were kept around 5%. Upon changing the feeding ratio of LLA to EO, the content in ester in the obtained copolymer varied (entry 11, Table 1). Analysis by GPC of the copolymer samples obtained shows unimodal traces with a narrow distribution of molar masses (FIG. 5); the latter being close to the theoretical values and to ones generated from NMR calculations. It was thus demonstrated that, under these conditions, EO and LLA copolymerized in a “living” manner and transesterification was totally suppressed.

It is believed that this is not only the first successful attempt at copolymerizing monomers as different as EO and LLA under “living” conditions, but it also proves that very small amounts of ester linkages can be incorporated in polyether chains, a feat never before achieved. When carried out in THF (entry 5, Table 1), a slightly polar solvent, a loss of control of the molar mass of copolymer sample was observed, indicating the occurrence of transesterification reaction and thus very likely of back-biting reactions.

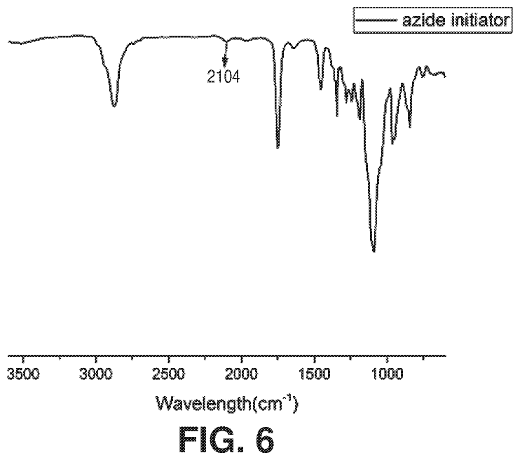

Apart from polymerizations initiated by the system PMBA/tBuP₄, other organic initiators ammonium and phosphonium halides, like TBACl and TBPCl, were also utilized in the presence of TEB for the copolymerizations. Similar results were obtained, but the ester contents within the isolated copolymer tended to be slightly higher than for the copolymers generated from the alkoxide/tBuP₄ system (entry 15, 19 and 20, Table 1). This may have been due to the difference of reactivity between EO and LLA in the presence of the various cations associated with alkoxides (vide infra). Using various initiators, difunctional and hetero-difunctional copolymers were also prepared. For instance, upon choosing bisphenol A as initiator, two hydroxyl-ended PEO were obtained including about 3% ester content (entry 13 of Table 1); if starting from allyl alcohol and tetrabutyl azide as initiators (entry 21, 22, Table 1), copolymer samples carrying vinyl and azide end groups were generated (FIG. 6), which are interesting and powerful functional groups for biological conjugation and application.

TABLE 1
Random copolymerization results of EO with LLA with rifferent initiating systems.

| Entry | EO/LLA/ | | Time | | Yield | Ester^{d} | | | | |
|---|---|---|---|---|---|---|---|---|---|---|
| No. | I/TEB | Initiator | (min) | Solvent | (%) | (%) | Mₙ₍ₜₕₑₒ₎^{c} | M_{n(NMR)}^{d} | M_{n(GPC)}^{e} | PDI |
| 1 | 600/0/1/5 | PMBA/P₄ | 10 | THF | 54 | 0 | 13800 | 15100 | 13100 | 1.28 |
| 2 | 500/0/1/5 | PMBA/P₄ | 30 | Tol | 95 | 0 | 19400 | 24000 | 21000 | 1.20 |
| 3 | 0/100/1/5 | PMBA/P₄ | 960 | THF | 0 | 0 | — | — | — | — |
| 4 | 0/100/1/5 | PMBA/P₄ | 960 | Tol | 0 | 0 | — | — | — | — |
| 5^{a} | 260/40/1/5 | PMBA/P₄ | 180 | THF | 40 | 7 | 9200 | 15100 | 5900 | 1.17 |
| 6 | 50/7/1/5 | PMBA/P₄ | 15 | Tol | 53 | 1 | 1700 | 2700 | 5200 | 1.19 |
| 7 | 100/15/1/5 | PMBA/P₄ | 45 | Tol | 65 | 1 | 4100 | 4700 | 7000 | 1.11 |
| 8 | 150/25/1/5 | PMBA/P₄ | 75 | Tol | 63 | 2 | 6400 | 6600 | 9500 | 1.18 |
| 9 | 200/30/1/5 | PMBA/P₄ | 120 | Tol | 70 | 3 | 9800 | 10000 | 11000 | 1.14 |
| 10 | 300/45/1/5 | PMBA/P₄ | 150 | Tol | 53 | 2 | 10500 | 10800 | 14200 | 1.13 |
| 11 | 300/60/1/5 | PMBA/P₄ | 360 | Tol | 66 | 7 | 13500 | 11600 | 10900 | 1.11 |
| 12 | 500/70/1/5 | PMBA/P₄ | 180 | Tol | 62 | 3 | 20000 | 23500 | 24000 | 1.20 |
| 13^{b} | 500/70/1/5 | BPA/P₄ | 180 | Tol | 68 | 3 | 21200 | 20100 | 22000 | 1.26 |
| 14 | 100/15/1/5 | PMBA/P₂ | 120 | Tol | 64 | 5 | 4200 | 5700 | 11000 | 1.17 |
| 15 | 200/40/1/5 | TBACl | 240 | Tol | 48 | 11 | 700 | — | 9800 | 1.19 |
| 16 | 200/40/1/5 | TBACl | 120 | Tol | 25 | 7 | 3500 | — | 6900 | 1.20 |
| 17 | 300/60/1/5 | PPNCl | 180 | Tol | 38 | 5 | 8100 | — | 9700 | 1.19 |
| 18 | 300/60/1/5 | TOACl | 420 | Tol | 37 | 9 | 7600 | — | 11800 | 1.11 |
| 19 | 300/60/1/5 | TBPCl | 420 | Tol | 52 | 16 | 10200 | — | 11400 | 1.18 |
| 20 | 300/60/1/5 | TBPCl | 210 | Tol | 20 | 9 | 3800 | — | 6800 | 1.17 |
| 21 | 300/60/1/5 | TBAA | 300 | Tol | 39 | 11 | 8800 | — | 9500 | 1.12 |
| 22 | 200/40/1/5 | Allyl A/P₄ | 150 | Tol | 67 | 3 | 9000 | 7800 | 14800 | 1.13 |

p-methyl benzyl alcohol (PMBA) was used with P₄ and P₂ otherwise noted, P₄ = t-BuP₄, P₂ = t-BuP₂,
^{a}diethylene glycol monomethyl ether as alcohol.
^{b}Bisphenol A is used as alcohol.
^{c}Mₙ₍ₜₕₑₒ₎ = (mₚ/N_{I}).
mₚ = Total weight of polymer recovered.
N_{I} = mole of initiator.
^{d}Ester content and M_{n(NMR)} calculated based on ¹H NMR.
^{e}GPC determined with THF as eluent and calibrated by polystyrene standards.

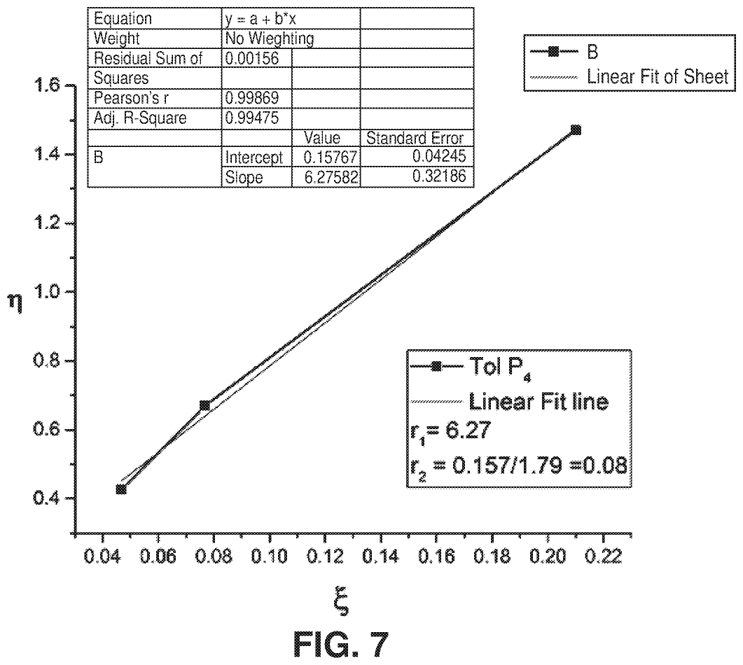

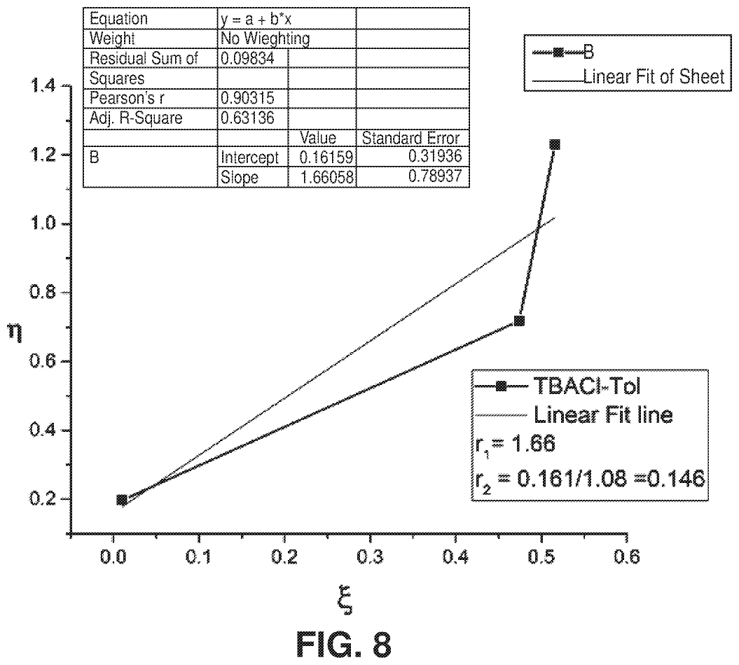

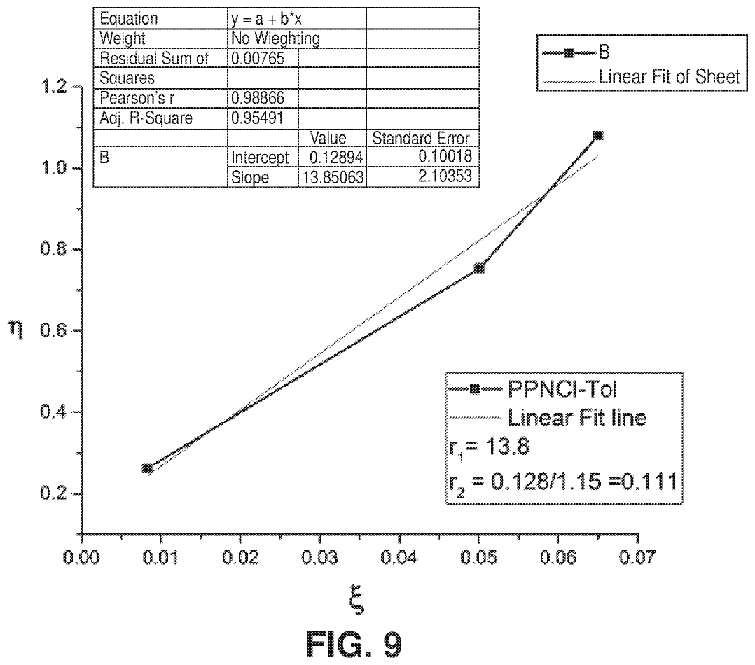

To identify the nature of the copolymer formed, kinetic data were collected and monomer conversions were measured under the same initial feeding ratio, using PMBA/tBuP₄, TBACl, and PPNCl as initiators. The related polymerization data are listed in Table 2. With increasing polymerization time, the ester content gradually increased, though at a much lower rate than the ether content, indicating that EO was consumed much faster. The reactivity ratio r_{EO} and r_{LLA} were calculated and the tendency of self-propagation or incorporation of the other monomer was determined by terminating the polymerization at different intervals and analyzing the composition of the corresponding copolymer. Various methods of determination of reactivity ratios were available including Mayo-Lewis, Fineman-Ross, and Kelen-Tüdos, etc. In this Example, the reactivity ratios were calculated using Kelen-Tüdos method. In the case of tBuP₄/alkoxide system, the reactivity ratio for EO r_{EO} was 6.27 and for LLA r_{LA} was 0.08. While with TBACl as initiator a value of 1.67 was found for r_{EO} and of 0.15 for r_{LLA} (see FIGS. 7-9). With the decrease of cation size associated with alkoxide, the reactivity of EO decreased, under a same feeding ratio, and therefore more ester units were incorporated. However, in both cases, the reactivities of EO were much higher than those of LLA, which resulted in a low content of LLA units in the obtained copolymer P(EO-co-LLA) and in very short ester segments.

TABLE 2
Copolymerization results of EO with LLA with different conversion

| Entry | EO/LLA/ | | Time | | Yield | Ester^{b} | | | | |
|---|---|---|---|---|---|---|---|---|---|---|
| No. | I/TEB | Initiator | (min) | Solvent | (%) | (%) | Mₙ₍ₜₕₑₒ₎^{a} | M_{n(NMR)}^{b} | M_{n(GPC)}^{c} | PDI |
| 1 | 300/60/1/5 | P₄ | 120 | Tol | 22 | 3 | 5200 | 7700 | 9000 | 1.18 |
| 2 | 300/60/1/5 | P₄ | 360 | Tol | 60 | 7 | 13500 | 11600 | 10900 | 1.11 |
| 3 | 300/60/1/5 | P₄ | 1080 | Tol | 74 | 10 | 16700 | 11400 | 12500 | 1.11 |
| 4 | 200/40/1/5 | TBACl | 240 | Tol | 48 | 11 | 7000 | — | 9800 | 1.19 |
| 5 | 200/40/1/5 | TBACl | 480 | Tol | 71 | 12 | 10300 | — | 11500 | 1.18 |
| 6 | 200/40/1/5 | TBACl | 840 | Tol | 91 | 14 | 13000 | — | 13100 | 1.17 |
| 7 | 200/40/1/5 | PPNCl | 180 | Tol | 52 | 4 | 7500 | — | 9100 | 1.19 |
| 8 | 200/40/1/5 | PPNCl | 300 | Tol | 62 | 6 | 9000 | — | 11000 | 1.17 |
| 9 | 200/40/1/5 | PPNCl | 450 | Tol | 74 | 8 | 10500 | — | 12200 | 1.16 |

PMBA was used with P₄ otherwise noted, P₄ = t-BuP₄.
^{a}Mₙ₍ₜₕₑₒ₎ = (mₚ/N_{I}), mₚ = Total weight of polymer recovered, N_{I} = mole of initiator.
^{b}Ester content and M_{n(NMR)} calculated based on ¹H NMR.
^{c}GPC determined with THF as eluent and calibrated by polystyrene standards.

Since Kelen-Tüdos method worked best for “instantaneous” composition and rather low conversions, the non-terminal model of chain copolymerization was used (BSL) for the determination of the reactivity ratios r_{EO} and r_{LLA} of the two monomers. This model assumes that the reactivity of the propagating species only depends on the reactivity of the incoming monomer, and ignores the nature of the last monomer featuring the active species; it is applicable up to full conversion. The reactivity ratios were calculated based on the data shown in Table 3 and it was found to be about equal to: r_{LLA}=0.17±0.04, r_{EO}=5.37±0.4 for P₄⁺ as counter cation, r_{LLA}=0.49±0.08, r_{EO}=2.07±0.25 for TBA⁺ and r_{LLA}=0.14±0.01, r_{EO}=6.61±0.67 for PPN⁺. In the three cases investigated with three different cations (P₄⁺, TBA⁺, PPN⁺) the product of reactivity ratios r_{EO}×r_{LLA} is very close to one, confirming the character by ¹H NMR which indicated the formation of gradient copolymers. The terminal model of ML for the determination of the reactivity ratios, r_{EO} and r_{LLA} was also tried. Assuming that the copolymers formed are of gradient nature with no tendency to blockiness or alternation. We derived a simple relation of reactivity ratios as function of the conversion upon starting from generic, conversion dependent version of the copolymer equation of Meyer and Lowry. The terminal model of ML thus affords for the copolymerization of EO with LLA in the presence of TEB the following values of reactivity ratios: r_{LLA}=0.19±0.02, r_{EO}=5.15±0.56 for P₄⁺, r_{LLA}=0.50±0.07, r_{EO}=2.03±0.27 for TBA⁺ and r_{LLA}=0.15±0.01, r_{EO}=6.49±0.46 for PPN⁺ (Table 3).

TABLE 3
Reactivity ratios calculated using different methods

| | | Kelen Tüdos | | BSL Model | | ML Model | |
|---|---|---|---|---|---|---|---|
| No. | initiator | r_{EO} | r_{LLA} | r_{EO} | r_{LLA} | r_{EO} | r_{LLA} |
| 1 | PMBA/ | 6.27 | 0.08 | 5.37 ± | 0.17 ± 0.04 | 5.15 ± | 0.19 ± 0.02 |
| | P₄ | | | 0.40 | | 0.56 | |
| 2 | TBACl | 1.67 | 0.15 | 2.07 ± | 0.49 ± 0.08 | 2.03 ± | 0.50 ± 0.07 |
| | | | | 0.25 | | 0.27 | |
| 3 | PPNCl | 13.80 | 0.11 | 6.61 ± | 0.14 ± 0.01 | 6.49 ± | 0.15 ± 0.01 |
| | | | | 0.67 | | 0.46 | |

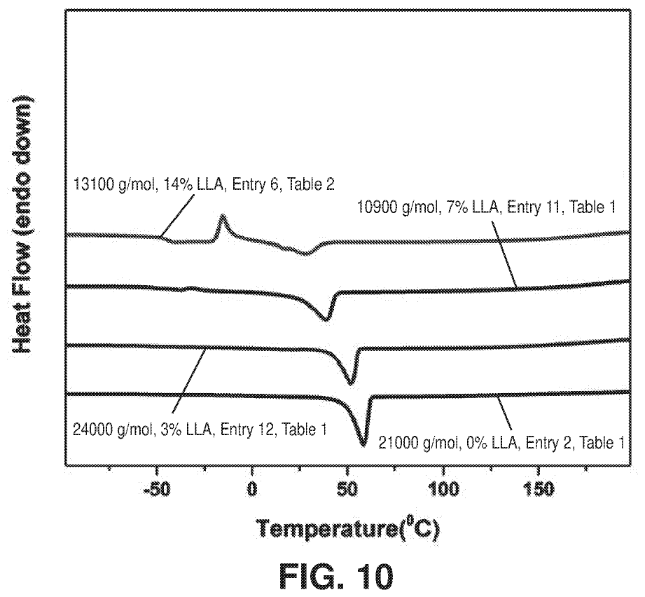

As one of the aims of this investigation was to control as precisely as possible the incorporation of ester units in the PEO chains and if possible to a limited percentage (˜5%), the thermal properties of the copolymer samples obtained were checked by DSC. The melting transitions of PEO were all detected, and compared to those of pure PEO; the melting temperature (Tₘ) of the copolymers obtained gradually decreased with more incorporation of ester units into the PEO backbone. With the incorporation of about 3% ester, Tₘ reduced to about 52.3° C. from about 58.9° C. On a further increment of ester linkages to about 7%, Tₘ decreased further to about 38.5° C. and then to about 28.6° C. on about 14% incorporation of ester units (FIG. 10). Especially, in the latter case due to more ester units incorporated, a pronounced cold crystallization transition at about −17.6° C. was detected. However, no melting transition of PLLA was detected, even for the sample containing about 14% of ester, indicating the incorporation of very short PLLA segments along the PEO backbone. As a comparison, a melting temperature (Tₘ) due to PLLA was clearly detected in the case of Gross' multiblock P(EO-co-LLA) copolymers which contained about 17% of ester units.

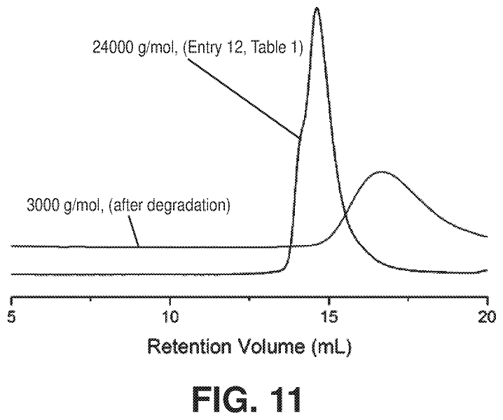

Lastly the degradation of P(EO-co-LLA) was performed to check the average length of PEO segments. The copolymer was dissolved in about 0.5 M NaOH solution in 40:60 methanol: water, and stirred for about two days to hydrolyze the ester linkages. The polymer recovered after such treatment was characterized by ¹H NMR, which indicated the complete degradation and disappearance of ester linkages. The molar mass of PEO after degradation was analyzed by GPC. As shown in FIG. 11, the copolymer sample exhibiting an initial molar mass of about 24 Kg/mol was reduced to about 3 Kg/mol.

In summary, through anionic ring opening copolymerization of EO and LLA, degradable poly(ethylene oxide)s were directly prepared in a controlled way with a narrow polydispersity and a well-defined structure. The presence of TEB selectively increased the reactivity of EO, and suppressed transesterification reactions. The method is general and can be applied not only to synthesize functionalized linear PEOs, but also branched PEOs with high molar mass without concern of the degradability issue. In addition, a metal-free synthesis gives more credit to this approach for biomedical applications.

### Example 2

### Degradable Poly(Ethylene Oxide) Through Anionic Copolymerization of Ethylene Oxide with Lactide or Carbon Dioxide

The scheme shown below illustrates a direct way of forming degradable PEG through anionic copolymerization of EO and lactide or carbon dioxide in the presence of trialkylborane. As described in this Example, the random incorporation of a very low content (around 5%) of lactide and carbon dioxide resulted in the formation of ester or carbonate linkages within the backbone of PEG chain, which imparted the obtained PEG with degradable properties; in addition, the copolymer obtained still maintained its hydrophilicity and well-defined structure. Heterobifunctional end-capped degradable PEG cam thus be prepared or derivatized to conjugate molecules for biological applications.

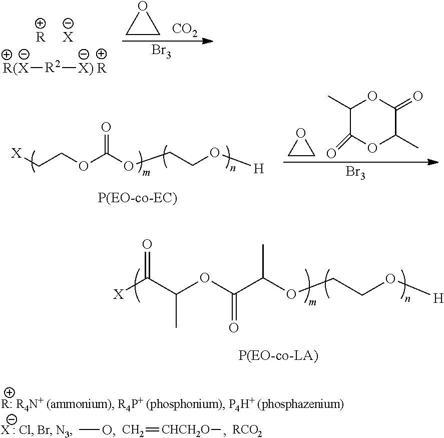

### Methods

Representative procedure for synthesis of poly(ethylene oxide)-co-(L-Lactide) using tetrabutylammonium chloride (TBACl) as initiator: A pre-dried 30 mL glass schlenk tube (80 mm×28 mm) composed of rotaflo stopcocks and fitted with magnetic stirring bar was used to carry out this reaction. Under argon atmosphere, 86 μL of triethyl borane (0.086 mmol) was first added to a solution of TBACl (4.8 mg, 17 μmol) in toluene (0.5 mL) in the glass schlenk tube. The premixed solution of L-Lactide (100 mg, 0.69 mmol) and ethylene oxide (150 mg, 3.47 mmol) in 1 mL of toluene were then added into initiator-borane system. The polymerization was carried out at room temperature for 4 hours under stirring. Then the reaction was quenched with few drops of 5% HCl in methanol and the solution of polymer was precipitated in cold diethyl ether. The obtained polymer after filtration was dried in a vacuum oven and characterized by GPC and NMR.

Representative procedure for synthesis of poly(ethylene oxide)-co-(L-Lactide) using P4 as initiator: A pre-dried 30 mL glass schlenk tube (80 mm×28 mm) composed of rotaflo stopcocks and fitted with magnetic stirring bar was used to carry out this reaction. Under argon atmosphere, to a solution of p-methyl benzyl alcohol (4.3 mg, 35 μmol) in toluene (0.5 mL), t-BuP4 solution (44 μL, 0.044 mmol) was charged into reaction flask, and stirred for a few minutes under RT. Then, triethyl borane (176 μL, 0.176 mmol) and the premixed monomer solution of L-Lactide (75 mg, 0.520 mmol) and ethylene oxide (152 mg, 3.47 mmol) in Toluene (1 mL) were sequentially added into the initiator-borane system and the polymerization was carried out at room temperature for 1 hour under stirring. The reaction was quenched with a few drops of 5% HCl in methanol and precipitated in cold diethyl ether. The polymer obtained after filtration was dried in vacuum oven and characterized by GPC and NMR.

Representative procedure for synthesis of poly(ethylene oxide)-co-(ethylene carbonate) using tetrabutyl ammonium chloride (TBACl) as initiator: A pre-dried 30 mL glass schlenk tube (80 mm×28 mm) composed of rotaflo stopcocks, septum and fitted with magnetic stirring bar was used to carry out this reaction. 27.8 mg of TBACl (100 μmol) was first charged under atmosphere of dried carbon dioxide, then dissolved in 2 mL of THF. Triethyl borane in THF (150 μL, 0.15 mmol) and EO (1 mL, 20 mmol) were injected sequentially into the tube. The polymerization was carried out under 1 bar of carbon dioxide at room temperature for 12 hours. The reaction was quenched with a few drops of 5% HCl in methanol and precipitated in cold diethyl ether. The polymer obtained after filtration was dried in vacuum oven and characterized by GPC and NMR.

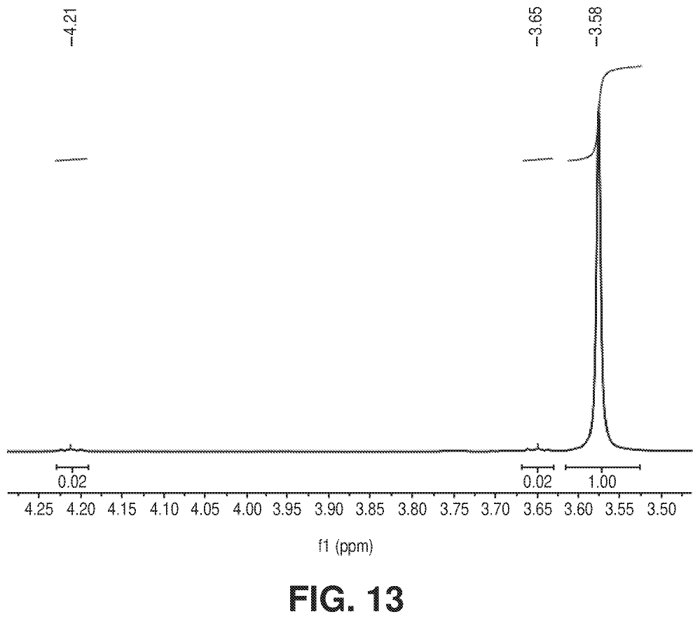

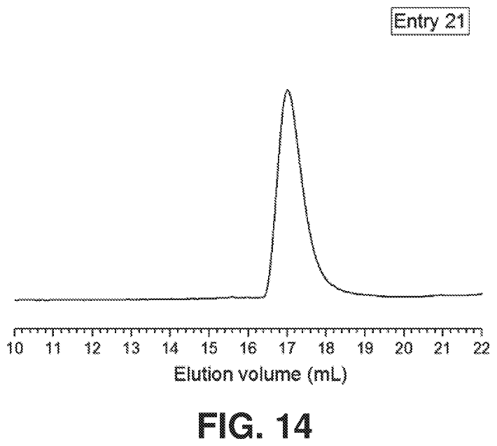

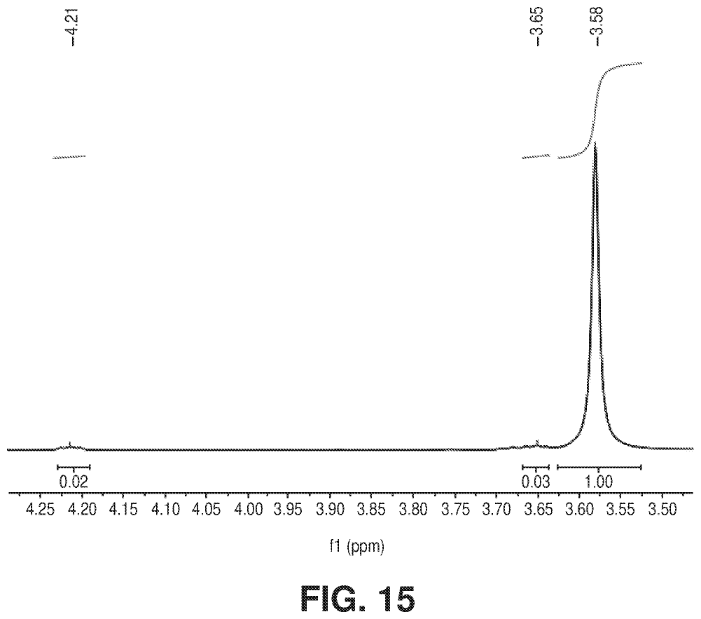

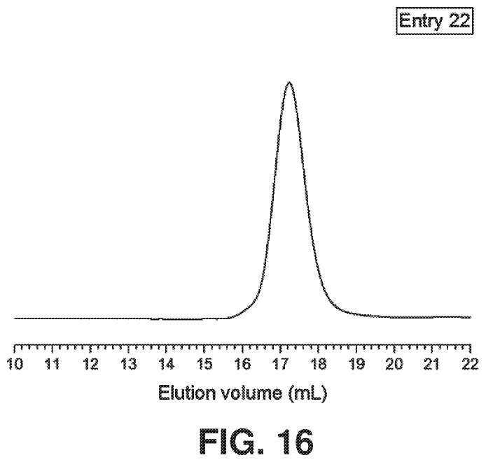

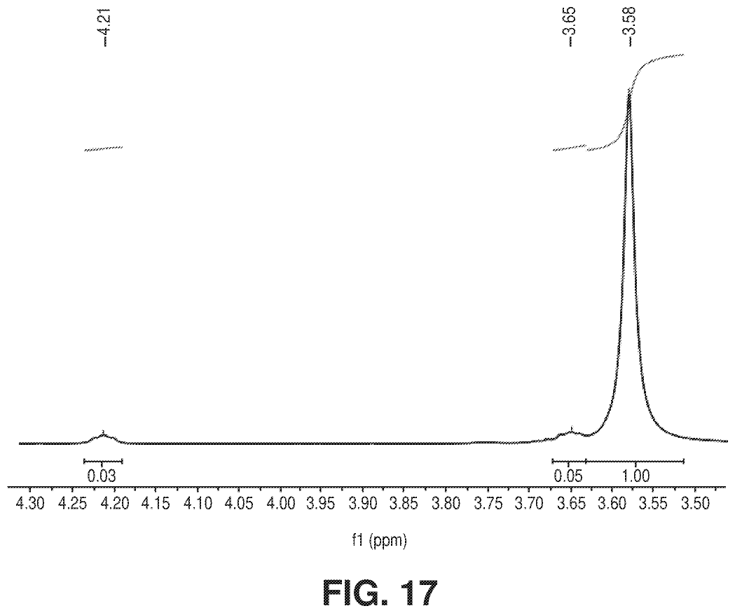

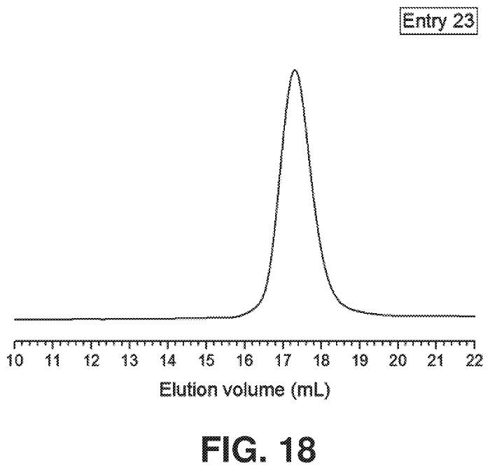

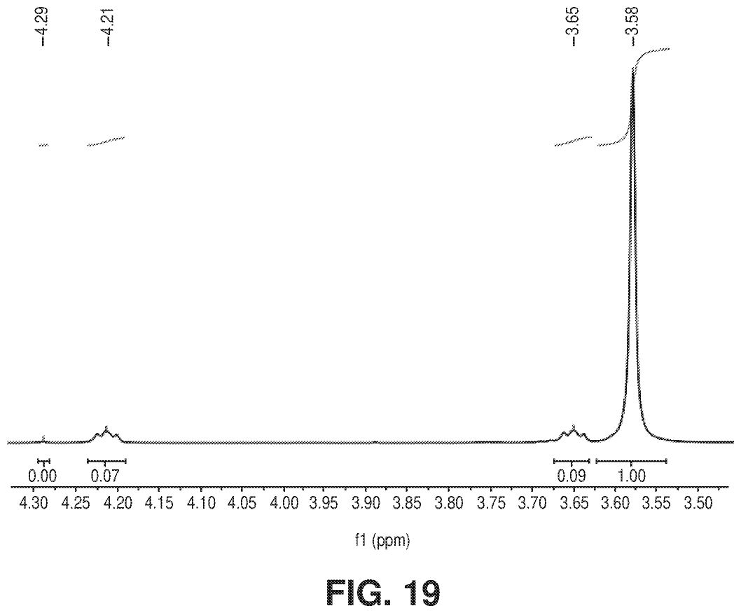

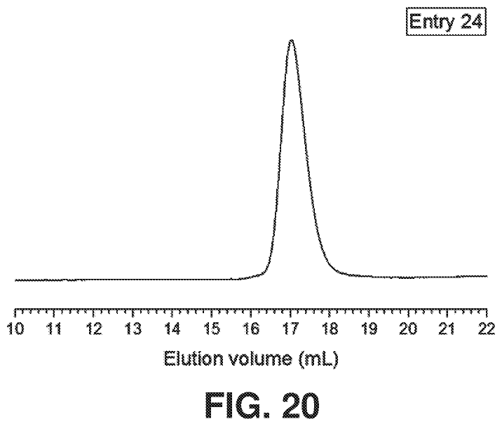

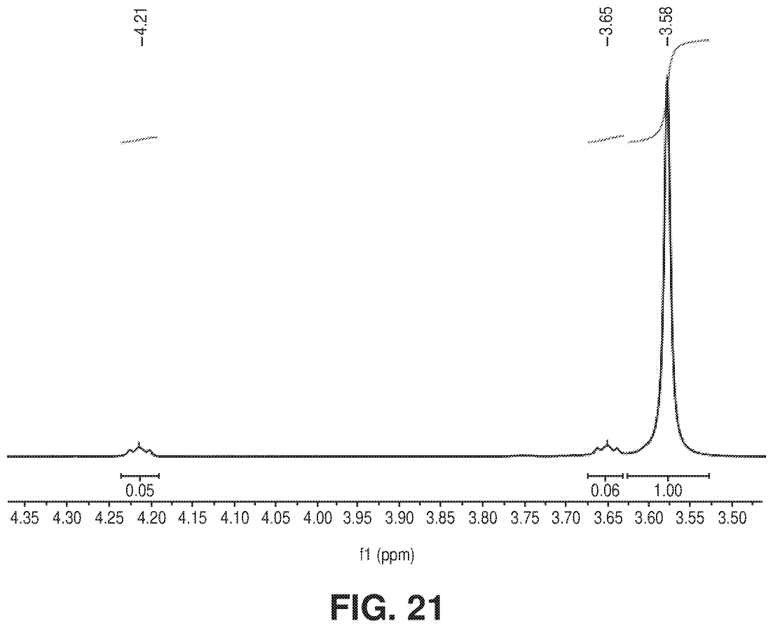

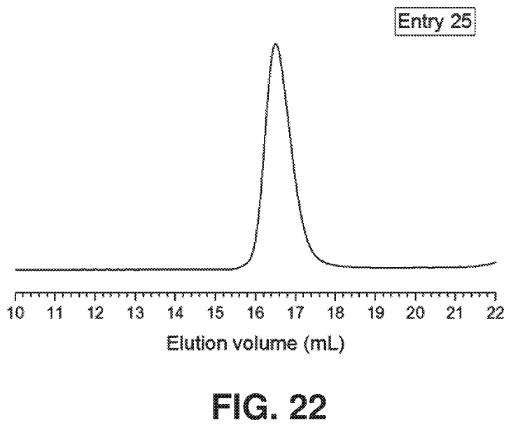

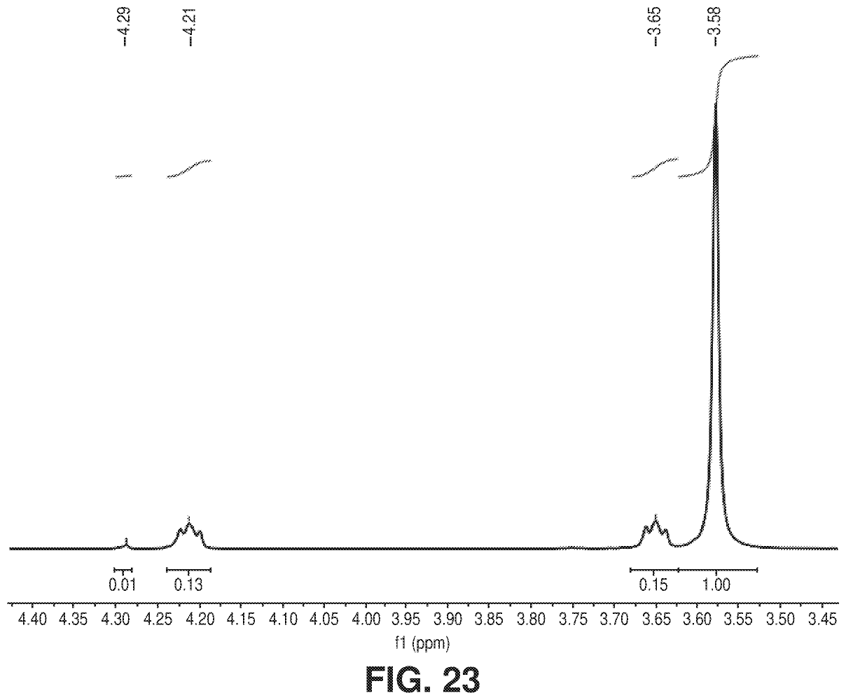

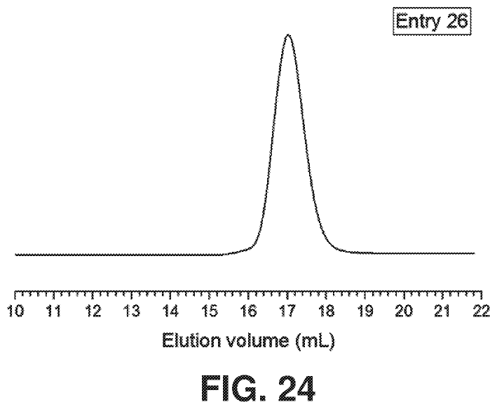

FIGS. 13-24 provide ¹H NMR spectra and GPC traces for certain entries presented below in Table 4.

TABLE 4
Random Copolymerization Results of EO respectively with LLA and CO₂

| Entry | EO/LLA/ | | Time | | Yield | Ester | | | | |
|---|---|---|---|---|---|---|---|---|---|---|
| No. | I/TEB | Initiator | (min) | Solvent | (%) | (%) | Mₙ₍ₜₕₑₒ₎ | M_{n(NMR)} | M_{n(GPC)} | PDI |
| 1 | 600/0/1/5 | P₄ | 10 | THF | 54 | 0 | 13800 | 15100 | 13100 | 1.28 |
| 2 | 500/0/1/5 | P₄ | 30 | Tol | 95 | 0 | 19400 | 24000 | 21000 | 1.20 |
| 3^{b} | 260/40/1/10 | K | 900 | THF | 56 | 3 | 12900 | 14100 | 10700 | 1.16 |
| 4^{b} | 260/40/1/5 | P₄ | 180 | THF | 40 | 7 | 9200 | 15100 | 5900 | 1.17 |
| 5 | 300/300/1/5 | TBACl | 660 | THF | 70 | 8 | 12100 | | 4800 | 1.11 |
| 6 | 50/7/1/5 | P₄ | 15 | Tol | 98 | 3 | 2100 | 2700 | 5200 | 1.19 |
| 7 | 100/15/1/5 | P₄ | 45 | Tol | 96 | 2 | 4100 | 4700 | 7000 | 1.11 |
| 8 | 150/30/1/5 | P₄ | 75 | Tol | 95 | 3 | 6400 | 6600 | 10500 | 1.10 |
| 9 | 200/30/1/5 | P₄ | 120 | Tol | 99 | 3 | 9300 | 10000 | 14600 | 1.11 |
| 10 | 300/50/1/5 | P₄ | 150 | Tol | 80 | 3 | 10900 | 10800 | 14200 | 1.13 |
| 11 | 300/60/1/5 | P₄ | 360 | Tol | 99 | 7 | 13500 | 11600 | 15300 | 1.11 |
| 12 | 500/70/1/5 | P₄ | 180 | Tol | 96 | 3 | 21100 | 23500 | 24000 | 1.20 |
| 13^{a} | 500/70/1/5 | P₄ | 180 | Tol | 99 | 4 | 21200 | 20100 | 22000 | 1.26 |
| 14 | 100/15/1/5 | P₂ | 120 | Tol | 96 | 5 | 4200 | 5700 | 11000 | 1.17 |
| 15 | 200/40/1/5 | TBACl | 240 | Tol | 48 | 11 | 7000 | — | 13400 | 1.10 |
| 16 | 200/40/1/5 | PPNCl | 180 | Tol | 87 | 3 | 7500 | — | 13900 | 1.12 |
| 17 | 300/50/1/5 | TOACl | 420 | Tol | 18 | 23 | 2400 | — | 11300 | 1.11 |
| 18 | 300/60/1/5 | TBPCl | 420 | Tol | 87 | 16 | 10900 | — | 15700 | 1.13 |
| 19 | 300/60/1/5 | TBAA | 300 | Tol | 65 | 11 | 8800 | — | 14200 | 1.12 |
| 20 | 75/10/1/5 | KOH | 75 | THF | 62 | 5 | 1600 | — | 3300 | 1.39 |
| 21^{c} | 200/0/1/2.0 | TBACl | 720 | THF | 100 | 2 | 8980 | — | 16800 | 1.03 |
| 22^{c} | 200/0/1/1.6 | TBACl | 720 | THF | 100 | 2 | 8980 | — | 16000 | 1.05 |
| 23^{e} | 200/0/1/1.4 | TBACl | 720 | THF | 100 | 2 | 9070 | — | 15200 | 1.04 |
| 24^{c} | 200/0/1/1.2 | TBACl | 720 | THF | 100 | 6 | 9300 | — | 17200 | 1.03 |
| 25^{d} | 200/0/1/2.0 | TBACl | 720 | THF | 100 | 5 | 9240 | — | 18600 | 1.05 |
| 26^{e} | 200/0/1/2.0 | TBACl | 720 | THF | 100 | 12 | 9860 | — | 17400 | 1.04 |

p-methyl benzyl alcohol was used with P₄ and P₂ otherwise noted, P₄ = t-BuP₄, P₂ = t-BuP₂, LLA = L-lactide, EO = Ethylene Oxide, THF = tetrahydrofuran, Tol = Toluene, TBACl = tetrabutyl ammonium chloride, PPNCl = Bis(triphenylphosphine)iminium chloride, TOACl = tetra octyl ammonium chloride TBPCl = tetra butyl phosphonium chloride, TBAA = tetra butyl ammonium azide. GPC determined with THF as eluent and calibrated by polysterene standards.
^{a}Bisphenol A is used as alcohol.
^{b}diethylene glycol monomethyl ether as alcohol.
^{c}polymerized 1 bar of carbon dioxide.
^{d}polymerized under 2 bar of carbon dioxide.
^{e}polymerized under 4 bar of carbon dioxide.

### Example 3

### Synthesis of PEO stars with Degradable Polycarbonate Core

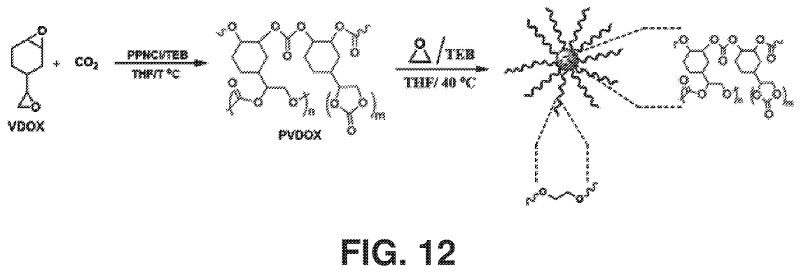

The degradable PEO stars was prepared by core first approach, where the core was composed of carbonate linkage to impart its degradability as shown in FIG. 12. Here, diepoxide, vinyl cyclohexene dioxide (VDOX) was used as cross-linker to form the degradable polycarbonate core through copolymerization with CO₂. In order to obtain soluble polycarbonate core with low crosslinking extent, very low amount of diepoxide was used and the ratio of VDOX to onium salt initiator was kept less than about 10. Once the core was formed, ethylene oxide together with THF solvent was injected into same Pan reactor after CO₂ was gradually released, and the polymerization of ethylene oxide with generated polycarbonate core were subsequently carried out at about 40° C. under stirring. The polymerization conditions and results are listed in Table 5.

Representative procedures for the synthesis of polyethylene oxide stars with polycarbonate cores (PVDOX-EO) by core first method. Reactions were carried out in 100 mL Pan reactor with in-built charging port which was dried at about 120° C. overnight and then evacuated in glovebox chamber for about 3 h. For illustrating the synthetic procedure, PEO star sample designated as PVDOX1-EO1 of entry 27 in Table 5 is taken as representative. PPNCl (0.114 g, 02 mmol) was first added into the reactor followed by THF (about 2.5 mL) and TEB (about 0.2 mL, about 1 eq.). To this reaction mixture, vinyl cyclohexene dioxide (about 0.14 g, about 1 mmol) was introduced and then reactor was closed and taken out from glovebox for charging at about 10 bar CO₂. The polymerization was carried out at about 80° C. for about 15 h. After cooling the reactor, CO₂ was slowly released to a minimum level, EO (about 2.6 mL, about 60 mmol), TEB (about 0.6 mL) and THF (about 20 mL) were charged to the reactor through charging port and polymerization was done at about 40° C. for about 15 h. Finally the reaction mixture was quenched with HCl in methanol (about 1 mol/L). The obtained crude product was purified by precipitating in diethyl ether and centrifuged and dried in vacuum oven at about 40° C. for about 15 h to obtain the final product (Yield=about 90%).

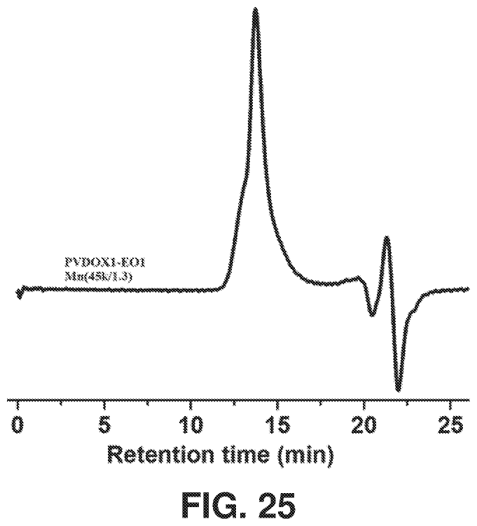

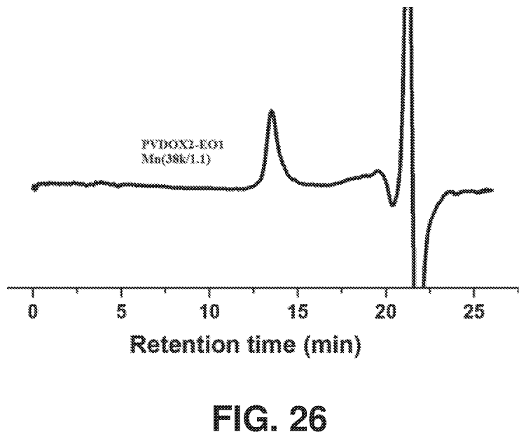

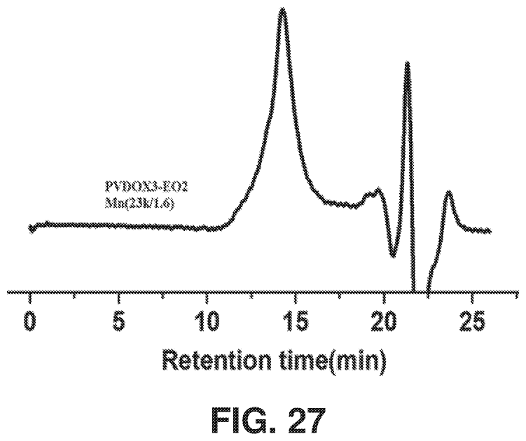

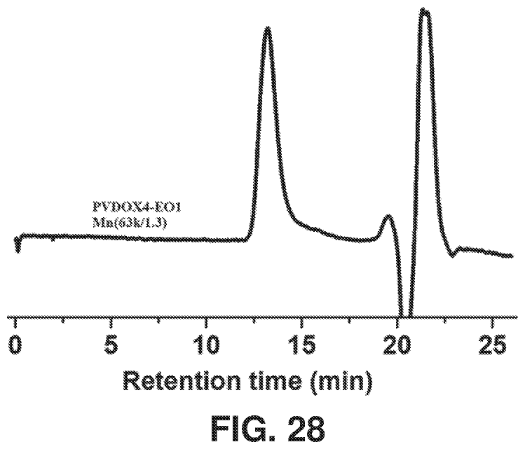

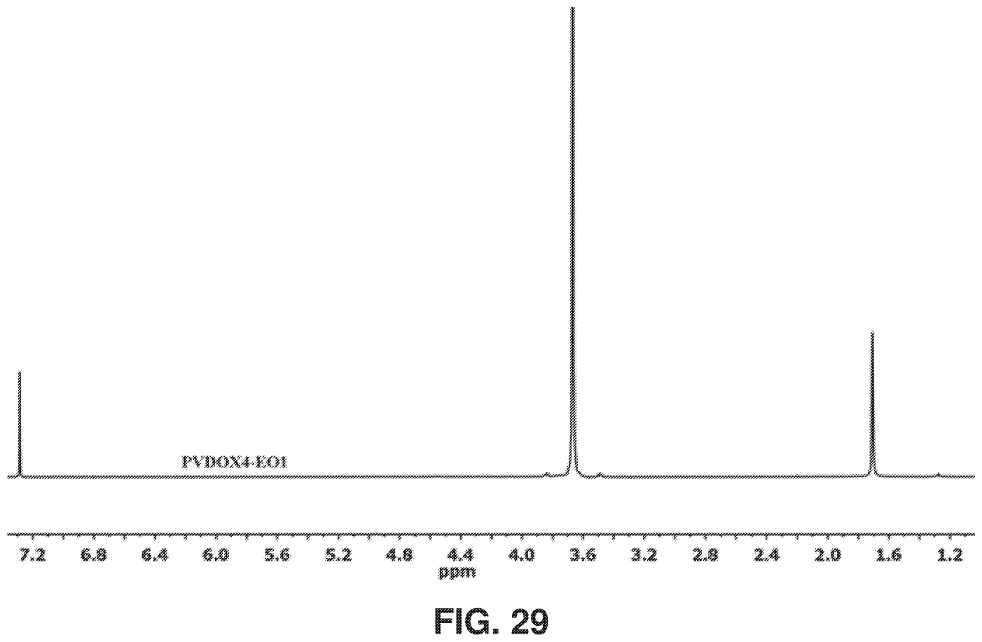

FIGS. 25-29 provide ¹H NMR spectra and GPC traces for certain entries presented in Table 5 below.

TABLE 5
Summary of PVDOX-EO star polymers synthesized by core-first method^{a}

| | | [PPNCl]:[TEB]: | | Carbonate | Mₙ/D^{b} | Mₙ/D^{c} | PEO Mₙ^{c} | |
|---|---|---|---|---|---|---|---|---|
| Entry | Reference | [VDOX]:[EO] | T (° C.) | of core (%) | (kg/mol) | (kg/mol) | (kg/mol) | N [symbol] ^{d} |
| 27 | PVDOX1- | 1:1:5:300 | 80 | 85 | 45.4/1.3 | 57.2 | 12.6 | 4.6 |
| | EO1 | | | | | | | |
| 28 | PVDOX2- | 1:1:5:300 | 70 | 88 | 38/1.1 | 77.7 | 12.2 | 6.1 |
| | EO1 | | | | | | | |
| 29 | PVDOX2- | 1:1:5:500 | 70 | 88 | 41.5/1.1 | 125 | 19.0 | 6.5 |
| | EO2 | | | | | | | |
| 30 | PVDOX3- | 1:1:5:100 | 60 | 90 | 23.4/1.6 | 40.3 | 4.4 | 7.8 |
| | EO2 | | | | | | | |
| 31 | PVDOX3- | 1:1:5:300 | 60 | 90 | 49.3/1.3 | 80.4 | 10.2 | 7.8 |
| | EO3 | | | | | | | |
| 32 | PVDOX3- | 1:1:5:400 | 60 | 90 | 48.1/1.5 | 140 | 15.0 | 9.3 |
| | EO4 | | | | | | | |
| 33 | PVDOX4- | 1:1:5:1000 | 50 | 90 | 63.2/1.3 | 835 | 40.1 | 20.8 |
| | EO1 | | | | | | | |
| 34 | PVDOX5- | 1:1:6:400 | 80 | 90 | 62.4/2 | 151 | 16.3 | 9.2 |
| | EO1 | | | | | | | |
| 35 | PVDOX7- | 1:1:5:5:500 | 70 | 88 | 44.4/1.6 | 148 | 19.2 | 7.7 |
| | EO1 | | | | | | | |
| 36^{e} | PVDOX9- | 1:1:5:300 | 70 | 89 | 38.8/1.4 | 70.1 | 12.0 | 5.8 |
| | EO1 | | | | | | | |
| 37^{f} | PVDOX10- | 1:1:5:300 | 80 | 90 | 34.7/1.5 | 143 | 12.8 | 11.2 |
| | EO1 | | | | | | | |
| 38^{g} | PVDOX11- | 1:1:5:300 | 80 | 90 | 54.7/1.2 | 90.2 | 12.1 | 7.4 |
| | EO1 | | | | | | | |

^{a}PVDOX was prepared using PPNCl as initiator at T (50-80° C.) under 10 bar of CO₂ with VDOX/THF(v/v) ratio as 1:2.5 or otherwise mentioned, followed by subsequent polymerization of EO with formed core by keeping ratio of PVDOX:TEB as 1:3 and EO/THF(v/v) ratio as 1:10 at 40° C. for 24 h.
^{b}Measured by GPC with THF as the eluent based on polystyrene standard.
^{c}Measured by GPC equipped with multiple laser light scattering (GPC-MALLS).
^{d}N [symbol] = M_{wLC} x arm_{wt%}/M_{n,PEO}.
^{e}Ratio of VDOX:THF was 1:2.
^{f}Monofuntional CHO was added to crosslinker in the ratio of VDOX:CHO as 1:1 and VDOX:THF was 1:2.5.
^{g}Polymerization was initiated by NBu₄Cl and reaction was carried out at 80° C. for 3 h. [symbol]
indicates data missing or illegible when filed

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A method of forming a degradable polymer, comprising:
contacting an ethylene oxide monomer with carbon dioxide or a cyclic ester in the presence of an alkyl borane and an initiator to form poly(ethylene oxide) having degradable carbonate linkages or degradable ester linkages incorporated into a polymer backbone.

2. The method according to claim 1, wherein the degradable polyether is formed under metal-free conditions.

3. The method according to claim 1, wherein the ethylene oxide monomer is selected from the group consisting of:

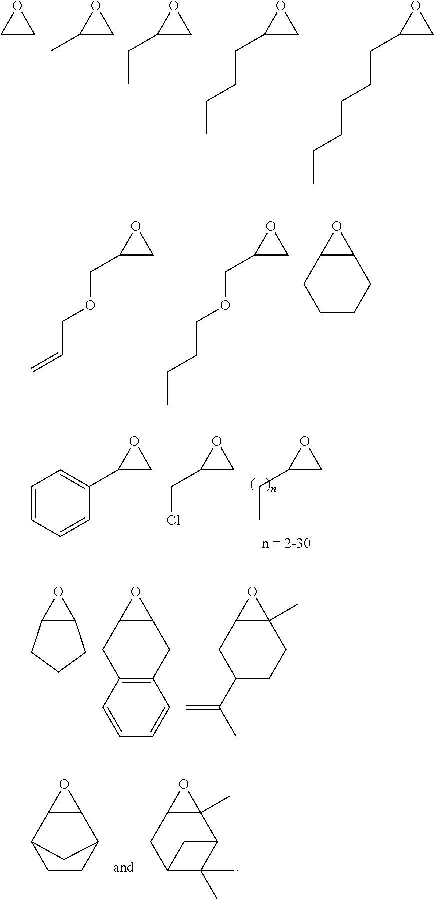

4. The method according to claim 1, comprising the cyclic ester, wherein the cyclic ester is selected from the group consisting of lactide, trimethylene carbonate, glycolide, β-butyrolactone, δ-valerolactone, γ-butyrolactone, γ-valerolactone, 4-methyldihydro-2(3H)-furanone, alpha-methyl-gamma-butyrolactone, ε-caprolactone, 1,3-dioxolan-2-one, propylene carbonate, 4-methyl-1,3-dioxan-2-one, 1,3-doxepan-2-one, and 5-C₁₋₄ alkoxy-1,3-dioxan-2-one.

5. The method according to claim 1, wherein the alkyl borane is selected from triethyl borane, triphenyl borane, tributylborane, trimethyl borane, triisobutylborane, and combinations thereof.

6. The method according to claim 1, wherein the initiator has a chemical formula selected from: {Y⁺, RO⁻}, {Y⁺, RCOO⁻}, {X⁺, N₃⁻}, and {X⁺, Cl⁻};
wherein is selected from K⁺, t-BuP₄⁺, and t-BuP₂⁺;
wherein X⁺ is selected from NBu₄⁺, PBu₄⁺, NOct₄⁺, and PPN⁺;
wherein RO⁻ is selected from 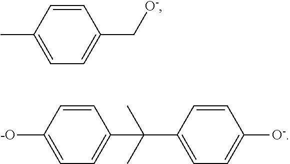
CH₃O(CH₂)₂O(CH₂)₂O⁻, and H₂C═CHCH₂O⁻.
wherein RCOO⁻ is aliphatic or aromatic carboxylate.

7. A degradable polyether formed according to claim 1.

8. The degradable polyether of claim 7 comprising degradable ester linkages or degradable carbonate linkages incorporated into a poly(ethylene oxide) backbone, wherein each degradable ester linkage and each degradable carbonate linkage comprises no more than 10 adjacent ester units or carbonate units, respectively or wherein the polyether comprises about 10% or less of degradable ester linkages and/or degradable carbonate linkages incorporated into the poly(ethylene oxide) backbone.

9. The degradable polyether of claim 7, conjugated with a biologically active molecule.

10. The degradable polyether of claim 9, wherein the biologically active molecule is selected from the group consisting of proteins, peptides, enzymes, medicinal chemicals organic moieties, and combinations thereof.

11. A method of forming a degradable polyether star, comprising:
contacting a diepoxide monomer with carbon dioxide or a cyclic ester in the presence of an initiator and a first amount of an alkyl borane to form a multifunctional core with degradable carbonate linkages or degradable ester linkages; and
contacting the multifunctional core with an ethylene oxide monomer in the presence of a second amount of the alkyl borane to form arms of a polyether attached to the multifunctional core.

12. The method according to claim 11, wherein the degradable polyether star is formed under metal-free conditions.

13. The method of claim 11, wherein each epoxide ring of the diepoxide monomer ring opens and copolymerizes with the carbon dioxide or cyclic ester.

14. The method of claim 11, wherein at least one epoxide ring of the diepoxide monomer copolymerizes with carbon dioxide to form degradable carbonate linkages.

15. The method of claim 11, wherein at least one epoxide ring of the diepoxide monomer copolymerizes with the cyclic ester to form degradable ester linkages.

16. The method of claim 11, wherein diepoxide monomer is selected from the group consisting of vinyl cyclohexene dioxide; butadiene dioxide; 1,2,3,4-diepoxybutane; 1,2,7,8-diepoxyoctane; 1,2,5,6-diepoxycyclooctane; dicylopentadiene diepoxide; and poly(ethylene glycol diglycidal); or diglycidyl ethers of 1,3-propanediol, 1,4-butanediol, 1,6-hexandiol, cyclohexane-1,4-diol, cyclohexane-1,1-dimethanol, cyclohexane-1,2-dimethanol, cyclohexane-1,3-dimethanol, cyclohexane-1,4-dimethanol, diethylene glycol, hydroquinone, resorcinol, 4,4-isopropylidenebisphenol, and naphthalene diols.

17. The method of claim 11, wherein the molar ratio of the diepoxide monomer to initiator is no greater than about 10.

18. The method of claim 11, wherein the polyether arms are attached to a multifunctional polycarbonate core.

19. The method of claim 11, wherein the a multifunctional core has at least 80% degradable carbonate linkages or ester linkages.

20. The method of claim 11, wherein the polyether arms have a number average molecular weight of about 4 kg/mol or greater.
